(19) United States
(12) Patent Application Publication
(10) Pub. No.: US 2011/0317763 A1
(43) Pub. Date: Dec. 29, 2011

(54) INFORMATION PROCESSING APPARATUS AND INFORMATION PROCESSING METHOD

(76) Inventor: Toshio Takada, Tokyo (JP)

(21) Appl. No.: 13/164,120

(22) Filed: Jun. 20, 2011

(30) Foreign Application Priority Data
Jun. 25, 2010 (JP) P2010-145439

(51) Int. Cl. H04N 7/32

(52) U.S. Cl. 375/240.13; 375/E07.243

(57) ABSTRACT

An information processing apparatus: a codec processing section performing codec processing using a plurality of codec processors; and a codec instruction section generating a buffer list in which a pointer indicating a position of a buffer used to store at least one of data before the codec processing and data after the codec processing is described in a transmission unit in accordance with a data transmission process from the codec processing section, allows list information used to acquire the buffer list to be included in a codec request, and issues the codec request to the codec processing section. The codec processing section acquires the buffer list based on the list information included in the codec request, transmits the data based on the buffer list by pipeline processing, and reads the data before the codec processing from the buffer or writes the data after the codec processing to the buffer.

### FIELD

The present disclosure relates to an information processing apparatus and an information processing method, and more particularly, to an information processing apparatus and an information processing method capable of shortening a time necessary until a codec result is obtained in response to a codec request.

### BACKGROUND

In the past, in a process of encoding or decoding image data, processing was performed in a frame unit by using an integrated circuit or the like capable of performing the processing within, for example, one frame period. FIG. 1 is a diagram illustrating processing performed, for example, when an encoding request is issued in an application. Each frame is encoded in an intra-prediction mode.

The application issues an encoding E1 request. A device driver manages encoding E1 data stored in a main memory so as to transmit the encoding E1 data to a piece of encoding hardware. Next, the device driver performs a process of transmitting the encoding E1 data to transmit the encoding E1 data to the encoding hardware. The encoding hardware performs an encoding E1 process on the supplied encoding E1 data, when the device driver completely transmits the encoding E1 data. The device driver performs a process of transmitting encoding E1 result data to transmit the encoding E1 result data obtained through the encoding E1 process to the main memory, when the encoding E1 process ends. Accordingly, the application acquires the encoding E1 result. Moreover, when the application acquires the encoding E1 result data in response to the encoding E1 request, the application issues a subsequent encoding E2 request. In this way, the process of transmitting the encoding data, the process of encoding the encoding data, and the process of transmitting the encoding result data are sequentially performed in response to the encoding request. The image data is generated from the encoded data by performing these processes in a decoding request.

Thus, when the process of transmitting the encoding data, the process of encoding the encoding data, and the process of transmitting the encoding result data are sequentially performed in response to the encoding request, for example, a latency time corresponding to three frames or more may be necessary until the result is acquired from the encoding request. Accordingly, real-time processing may not be performed.

For this reason, there is provided a mechanism (command queuing) capable of performing a plurality of encoding requests or a plurality of decoding requests to continuously perform the encoding process or the decoding process.

FIG. 2 is a diagram illustrating a command queuing process. For example, the application queues the encoding request so that the subsequent encoding process is performed immediately after the encoding process.

When the encoding E1 request is issued from the application, the device driver performs a data transmission process of transmitting the stored image data to an encoder. The device driver reads the encoding E1 data stored in, for example, a main memory and performs a data management process of transmitting the encoding E1 data to the encoder. Subsequently, the device driver stores the encoding E1 data in an encoding frame buffer MA1 of the encoding hardware.

Moreover, when an encoding E2 request is issued from the application, the device driver performs the data transmission process of transmitting the stored image data to the encoder. The device driver reads the encoding E2 data stored in, for example, the main memory of the information processing apparatus and performs the data management process of transmitting the encoding E2 data to the encoder. Subsequently, the device driver reads and stores the encoding E2 data in an empty encoding frame buffer MA2 of the encoding hardware. Thus, whenever the encoding request is issued from the application, the device driver stores the encoding data in an empty encoding frame buffer of the encoding hardware.

The encoding hardware performs an encoding E1 data reading process of reading the encoding E1 data stored in the encoding frame buffer MA1 in a codec processor. The encoding hardware performs an encoding E1 data encoding E1 process and an encoding E1 result data writing process of writing the encoding E1 result data in an encoding result frame buffer MB1.

The encoding hardware performs encoding E2 data processing in parallel with the encoding E1 data processing. That is, the encoding hardware performs an encoding E2 data reading process of reading the encoding E2 data stored in the encoding frame buffer MA2 to another codec processor. Moreover, the encoding hardware performs encoding E2 processing on the encoding E2 data and an encoding E2 result data writing process of writing the encoding E2 result data in an encoding result frame buffer MB2. Moreover, when the encoding data is stored in another encoding frame buffer, the encoding hardware processes this encoding data in parallel.

The device driver performs an encoding E1 result data transmitting process of transmitting the encoding E1 result data to the main memory, when the encoding E1 result data is written in the encoding result frame buffer MB1. Accordingly, the application acquires the encoding E1 result.

The device driver performs an encoding E2 result data transmitting process of transmitting the encoding E2 result data to the main memory in parallel, when the encoding E2 result data is written in the encoding result frame buffer MB2. Accordingly, the application acquires the encoding E2 result. Moreover, the device driver performs an encoding result data transmitting process in parallel, when the encoding result data is written to another encoding result frame buffer.

Thus, since the processes for the encoding requests can be performed in parallel, the real-time processing can be performed. Moreover, even in the decoding request, the real-time processing can be performed by performing the same process as that of the encoding request.

As a method of performing the processes in parallel, JP-A-2004-356857 discloses a method of dividing one screen into a plurality of screens and integrating the encoded data obtained by encoding the divided screens into one screen. JP-A-2009-044537 discloses a method of selecting a plurality of video streams and performing a process of decoding the selected video streams in parallel.

### SUMMARY

When the encoding process or the decoding process is performed in real time through the queuing process, the data before encoding (before the decoding process) and the data after encoding (after the decoding process) have to be accumulated in a frame buffer. Therefore, a lot of memory resources are necessary. Moreover, since it is necessary to manage the buffer, the processing may become complicated.

When the request being queued is cancelled during the queuing of the encoding request or the decoding request, it is necessary to perform an order advancing process after elimination of the corresponding queuing command or a buffer management process accompanied with the order advancing process. Therefore, the cancellation mechanism becomes complicated.

When the codec processings are performed in parallel, as in JP-A-2004-356857 and JP-A-2009-044537, a process of reading the data from a main memory before the codec processing or a process of writing the data to the main memory after the codec processing has to be performed at high speed. Otherwise, a long time is necessary until the codec result is obtained.

Thus, it is desirable to provide an information processing apparatus and an information processing method capable of shortening a time necessary until a codec result is obtained in response to a codec request with a simple configuration.

An embodiment of the present disclosure is directed to an information processing apparatus including: a codec processing section performing codec processing using a plurality of codec processors; and a codec instruction section generating a buffer list in which a pointer indicating a position of a buffer used to store at least one of data before the codec processing and data after the codec processing is described in a transmission unit in accordance with a data transmission process from the codec processing section, allows list information used to acquire the buffer list to be included in a codec request, and issues the codec request to the codec processing section. The codec processing section acquires the buffer list based on the list information included in the codec request, transmits the data based on the buffer list by pipeline processing, and reads the data before the codec processing from the buffer or writes the data after the codec processing to the buffer.

According to the embodiment of the present disclosure, the buffer list is generated in which the pointer indicating the position of the buffer used to store at least one of the data before the codec processing and the data after the codec processing is described in the transmission unit in accordance with the data transmission process from the codec processing section. The list information used to acquire the buffer list is included in the codec request, and thus the codec request is issued to the codec processing section. For example, a scatter gather list of the buffer used to store the data before the codec processing or the data after the codec processing is generated and the buffer list is generated by re-listing the scatter gather list in the transmission unit.

When the codec request issued from the codec instruction section is an encoding request, screen division information is included in the encoding request. The codec processing section performs the encoding process by distributing the data before the codec processing to the plurality of codec processors for each of the divided screens based on the screen division information. The transmission unit is a unit of a data amount suitable for at least one of the distributing of the data and the encoding process. For example, in the data transmission process of the encoded data, the codec processing section determines the transmission unit so that a data amount of invalid data added to encoded data, which is obtained through the encoding process by the codec processing section, to allow the encoded data to have a data amount of the transmission unit is reduced to improve transmission efficiency. Moreover, the codec processing section sets the area used to store the encoded data for each of the divided screen in advance in a codec memory used to store the encoded data obtained through the encoding process and sets the area so as to have a size of the maximum code generation amount.

When the codec request issued from the codec instruction section is a decoding request, the codec processing section divides the encoded data read from the buffer by the pipeline processing for each of the divided screens, distributes the divided encoded data to the plurality of codec processors, so that the codec processors each perform the decoding process. A unit of a data amount suitable for the transmission of the image data for each of the divided screens is set as the transmission unit. Moreover, the codec processing unit stores the image data obtained through the decoding process in the corresponding area of the memory area set in advance for each of the divided screens, and reads and outputs the stored image data to an image display area in correspondence with the image display area.

Another embodiment of the present disclosure is directed to an information processing method including: generating a buffer list in which a pointer indicating a position of a buffer used to store at least one of data before codec processing and data after the codec processing is described in a transmission unit in accordance with a data transmission process from a codec processing section performing the codec processing using a plurality of codec processors, allowing list information used to acquire the buffer list to be included in a codec request, and issuing the codec request to the codec processing section by a codec instruction section; and acquiring the buffer list based on the list information included in the codec request, transmitting the data based on the buffer list by pipeline processing, and reading the data before the codec processing from the buffer or writing the data after the codec processing to the buffer by the codec processing section.

According to the embodiments of the present disclosure, the buffer list is generated in which the pointer indicating the position of the buffer used to store at least one of the data before the codec processing and the data after the codec processing is described in the transmission unit in accordance with the data transmission process from the codec processing section. The list information used to acquire the buffer list is included in the codec request, and thus the codec request is issued to the codec processing section. The codec processing section performing the codec processing using the plurality of codec processors acquires the buffer list based on the list information included in the codec request and transmits the data based on the buffer list by the pipeline processing. The codec processing section reads the data before the codec processing from the buffer or writes the data after the codec processing to the buffer. Thus, since at least one of the data before the codec processing and the data after the codec processing is transmitted at high speed, it is possible to shorten the time necessary to obtain the codec result in response to the codec request from the issue of the codec request with the simple configuration.

### BRIEF DESCRIPTION OF THE DRAWINGS

FIG. 1 is a diagram illustrating an operation of issuing an encoding request according to the related art.

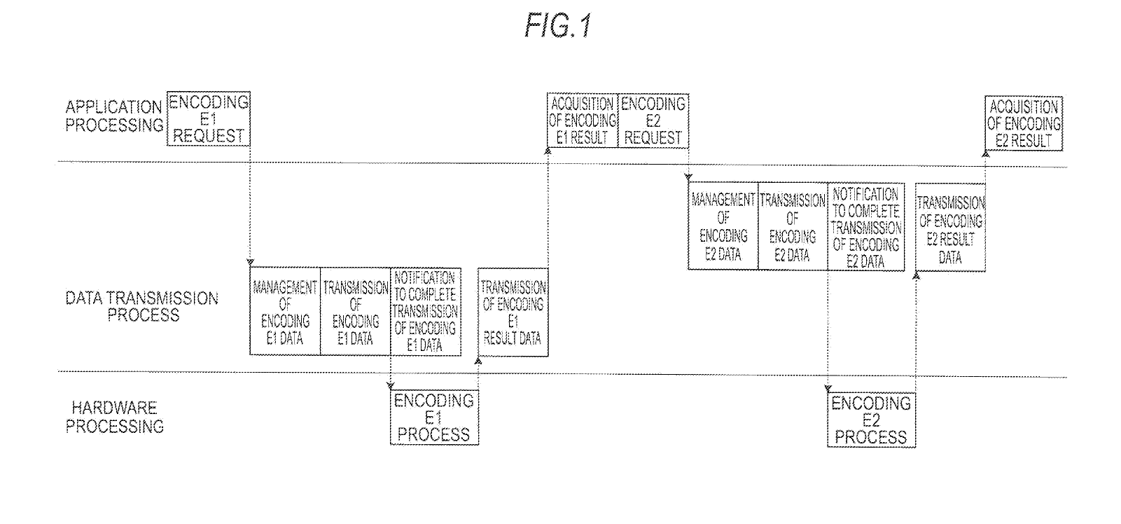

FIG. 2 is a diagram illustrating a command queuing process.

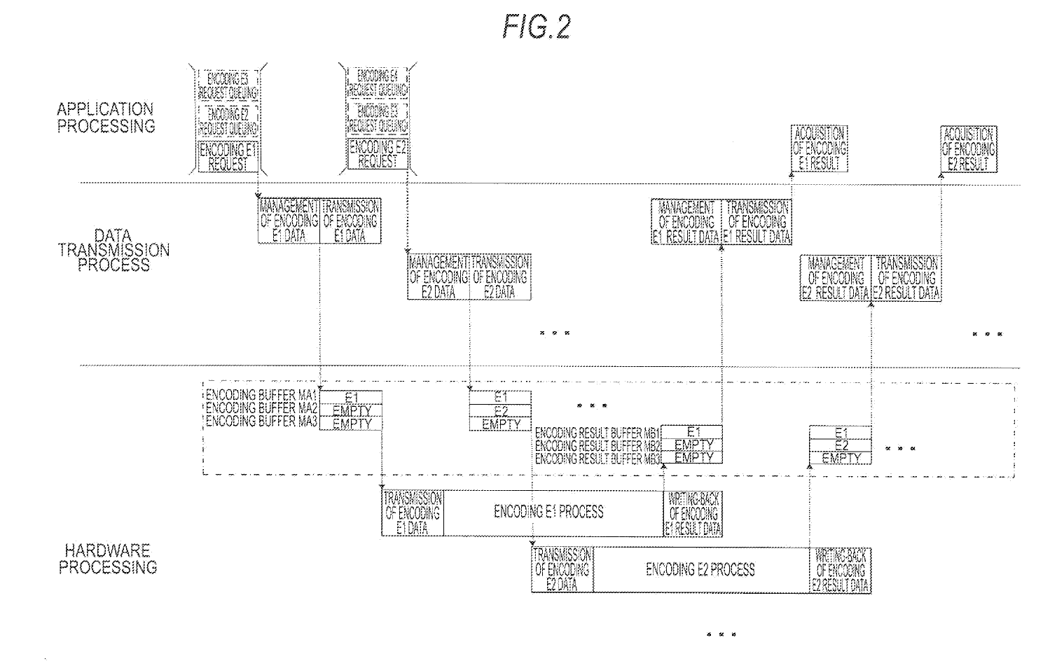

FIG. 3 is a diagram illustrating the configuration of an information processing apparatus.

FIG. 4 is a diagram illustrating a part of a program included in an operating system.

FIG. 5 is a diagram illustrating pipeline processing when an encoding process is performed.

FIG. 6 is a diagram illustrating the flow of processing of the operating system and a codec processing section when an encoding process is performed.

FIG. 7 is a diagram illustrating a scatter gather list, a buffer list, and list information.

FIG. 8 is a diagram illustrating a specific example of data transmission management of the codec processing section.

FIG. 9 is a diagram illustrating a control order of the encoding process.

FIG. 10 is a diagram illustrating an encoding process on an image with a 4 K size.

FIG. 11 is a diagram illustrating another encoding process on an image with a 4 K size.

FIG. 12 is a diagram illustrating pipeline processing when a decoding process is performed.

FIG. 13 is a diagram illustrating the flow of processing of the operating system and a codec processing section when a decoding process is performed.

FIG. 14 is a diagram illustrating a scatter gather list, a buffer list, and list information.

FIG. 15 is a diagram illustrating a specific example of data transmission management of the codec processing section.

FIG. 16 is a diagram illustrating a control order of the decoding process.

FIG. 17 shows diagrams illustrating an example of the relation between an output order of the image data and a display image.

### DETAILED DESCRIPTION

Hereinafter, embodiments of the present disclosure will be described in the following order.

1. Configuration of Information Processing Apparatus

2. First Embodiment (When Encoding Process Is Performed)

2-1. Data Transmission of Encoding Process

2-2. Encoding Process

2-3. Specific Example of Data Transmission Management

2-4. Another Specific Example of Data Transmission Management

3. Second Embodiment (When Decoding Process Is Performed)

3-1. Data Transmission of Decoding Process

3-2. Decoding Process

3-3. Specific Example of Data Transmission Management

3-4. Output Processing of Decoding Result

### 1. Configuration of Information Processing Apparatus

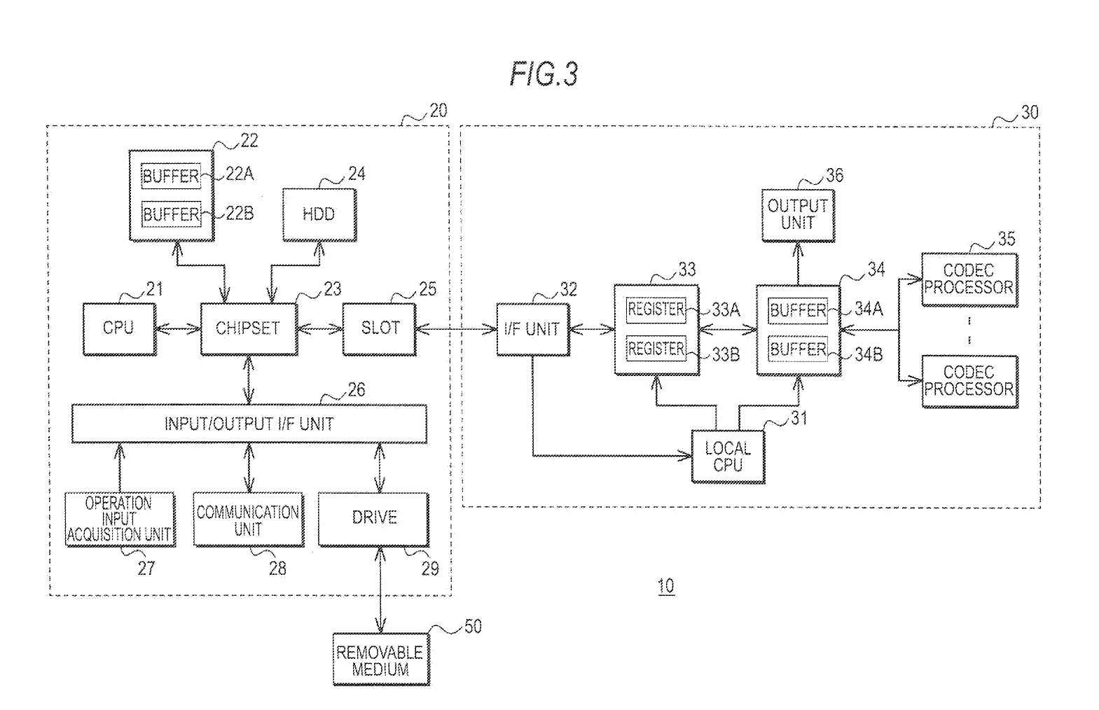

FIG. 3 is a diagram illustrating the configuration of an information processing apparatus 10. For example, the information processing apparatus 10 is a general workstation or personal computer. The information processing apparatus includes a main section 20 which serves as a codec instruction section and a codec processing section 30 which performing codec processing using a plurality of codec processors.

The main section 20 generates a buffer list in which a pointer indicating the position of a buffer used to store at least one of data before codec processing or after codec processing is described in a transmission unit in accordance with a process of transmitting data from the codec processing section 30. The main section 20 allows list information used to acquire the buffer list to be included in a codec request and issues the codec request to the codec processing section 30.

The codec processing section 30 acquires the buffer list based on the list information included in the codec request. The codec processing section 30 performs a data transmission process by pipeline processing based on the acquired buffer list. The codec processing section 30 reads data before the codec processing from the buffer or writes data after the codec processing to the buffer.

The main section 20 includes a CPU 21, a main memory 22, a chipset 23, an HDD 24, a slot (for example, a slot in conformity with the PCI Expression (trademark) standard) 25, and an input/output interface (I/F) unit 26. Moreover, an operation input acquisition unit 27, a communication unit 28, and a drive 29 are connected to the input/output I/F unit 26.

The CPU 21 controls the entire information processing apparatus 10 and operates an operating system or various kinds of application programs stored in the HDD 24 and the like to perform, for example, a video editing process and a video compression/decompression process.

The main memory 22 appropriately stores programs executed by the CPU 21, data, or the like.

The chipset 23 has necessary functions of a timer, interruption, a circuit controlling the main memory 22, and the like.

The HDD 24 stores an operating system, various kinds of application programs, the data before the codec processing, and the data after the codec processing, and the like.

The slot 25 is configured so that a board for expanding the functions of the information processing apparatus 10 can be inserted. For example, when codec processing is performed on video data, the codec processing section 30 is inserted into the slot 25.

The operation input acquisition unit 27 receives an input operation from a user and notifies the CPU 21 of the input operation from the user via the input/output I/F Unit 26 and the chipset 23.

The communication unit 28 is connected to an external network such as the Internet or a LAN or another apparatus to carry out communication.

The drive 29 is configured so that a removable medium 50 such as a magnetic disc, an optical disc, a magneto-optical disc, or a semiconductor memory can be mounted. The drive 29 is configured so that information can be read from or written to the mounted removable medium 50.

The codec processing section 30 is a peripheral device used by an application such as non-linear editing executed by the information processing apparatus 10. The codec processing section 30 performs codec processing on the data supplied from the main section 20. Moreover, the codec processing section 30 supplies the data after the codec processing to the main section 20 or outputs the data after the codec processing to an external apparatus.

The codec processing section 30 includes a local CPU 31, a codec interface (I/F) unit 32, a DMAC (Direct Memory Access Controller) 33, a codec memory 34, a plurality of codec processors 35, and an output unit 36.

The local CPU 31 controls each unit of the codec processing section 30 in response to an encoding request or a decoding request from the main section 20 and allows the codec processing section 30 to perform processing in response to the encoding request or the decoding request.

The codec I/F unit 32 is an interface which is used to transmit data to the main section 20 or communicate with the main section 20. For example, the codec I/F unit 32 outputs the data before the codec processing, which is read from the main section 20, to the DMAC 33. Moreover, the codec I/F unit 32 outputs the data after the codec processing, which is supplied from the DMAC 33, to the main section 20. When the codec request is issued from the main section 20, the codec I/F unit 32 outputs the codec request to the local CPU 31. Moreover, the codec I/F unit 32 outputs a codec completion notification from the local CPU 31 to the main section 20. The codec I/F unit 32 outputs a request for the list information described below from the local CPU 31 to the main section 20 and supplies the list information supplied from the main section 20 to the local CPU 31.

The DMAC 33 includes a register 33-R used when data is transmitted from the main section 20 to the codec memory 34 and a register 33-T used when data is transmitted from the codec memory 34 to the main section 20. The DMAC 33 performs DMA transmission on the data before the codec processing or the data after the codec processing between the codec memory 34 and the main memory 22 of the main section 20 under the control of the local CPU 31.

The codec memory 34 stores the data before the codec processing which is supplied from the DMAC 33 and the data after the codec processing which is supplied from the codec processors 35.

The plurality of codec processors 35 perform codec processing under the control of the local CPU 31. That is, each codec processor 35 reads data to be subjected to the codec processing from the codec memory 34 to perform the codec processing. Moreover, each codec processor 35 stores the data after the codec processing in an area of the codec memory 34 set in advance for each codec processor.

The output unit 36 outputs the data after the codec processing stored in the codec memory 34 as data with a corresponding format to an external apparatus, when the output unit 36 outputs the data after the codec processing to the external apparatus.

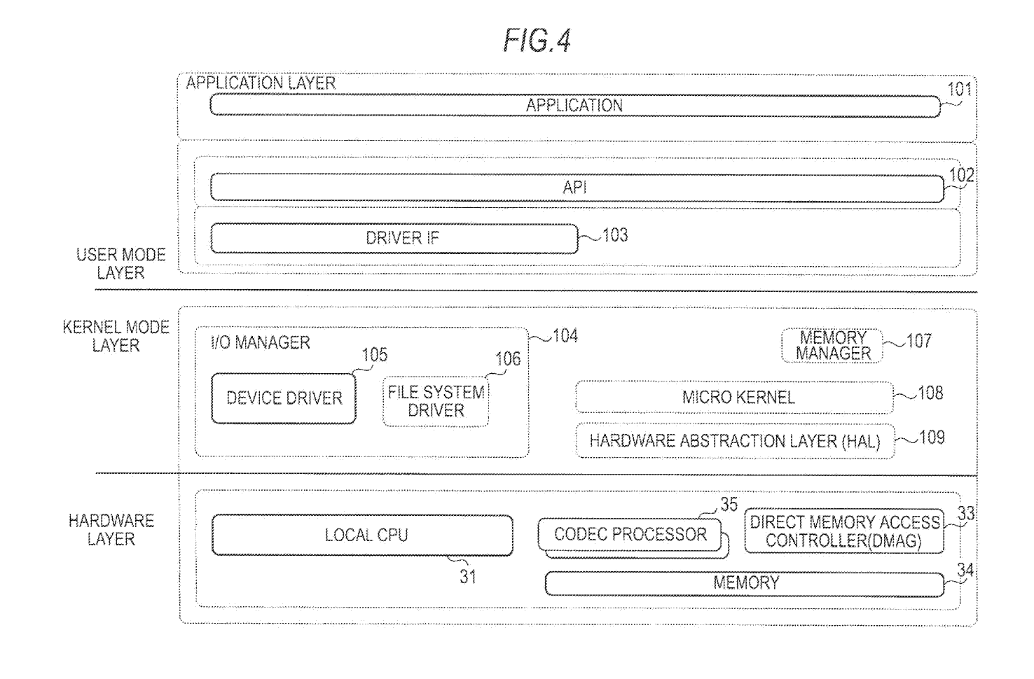

FIG. 4 is a diagram illustrating a part of a program included in an operating system operating in the main section 20 of the information processing apparatus 10. The program is separated into a user mode layer and a kernel mode layer. A hardware layer corresponds to the codec processing section 30.

The user mode layer includes a piece of application software (hereinafter, referred to as an “application”) 101, an API (Application Program Interface) 102, and a driver interface 103. The kernel mode layer includes softwares such as an I/O manager 104, a device driver 105, a file system driver 106, a memory manager 107, a micro kernel 108, and an HAL (Hardware Abstract Layer) 109.

The application 101 is a piece of software which issues the codec request in response to a request of a user or the like. The API 102 enables various kinds of services of the kernel mode layers to be used by the application 101. The driver interface 103 enables the device driver of the kernel mode layer to be used by the application 101 via the API 102.

The I/O manager 104 is a module which manages input and output in an integrated manner. The I/O manager 104 has smaller components such as a device driver 105 and a file system driver 106 therein.

The device driver 105 eliminates a difference between specific devices and supplies an interface not dependent on a device to an upper module. The device driver 105 allows list information used to acquire a buffer list described below to be included in a codec request and issues the codec request to the codec processing section 30.

The file system driver 106 can gain access to a file or a folder stored in the HDD 15 by managing information regarding the file or the folder stored in a memory device such as the HDD 15.

The memory manager 107 allows a virtual memory space to be used in each processor. The micro kernel 108 performs processings such as thread scheduling, interruption, and exception. The HAL 109 eliminates a difference between the kinds of hardwares connected to a slot or the like of the information processing apparatus 10 and supplies an abstract service of each service of the operating system. That is, the HAL 109 enables various kinds of services of the operating system to gain access to the hardware connected to the slot or the like regardless of the difference between the kinds of hardware.

The codec processing section 30 serving as the hardware layer acquires the data before the codec processing from the main section 20 and stores the data before the codec processing in the codec memory 34. The codec processing section 30 allows the plurality of codec processors 35 to perform the codec processing on the data before the codec processing stored in the codec memory 34 and stores the data after the codec processing in the codec memory 34. Moreover, the codec processing section 30 transmits the data after the codec processing stored in the codec memory 34 to the main section 20 and gives a response indicating that the codec processing ends in response to the codec request.

### 2. First Embodiment

Next, a case will be described in which the main section 20 serving as a codec instruction section issues an encoding request as the codec request according to a first embodiment. When the codec request is issued, the codec processing section 30 encodes encoding image data of the main memory 22 of the main section 20 and performs an encoding process of writing back the encoded data (encoding result data) to the main memory 22. Moreover, each frame is encoded in an intra-prediction mode.

### [2-1. Data Transmission of Encoding Process]

In the information processing apparatus 10, the data transmission process is performed from the codec processing section 30 in order to efficiently transmit the data between the main section 20 and the codec processing section 30. The codec processing section 30 performs a process of transmitting the encoding image data from the main memory 22 of the main section 20 to the codec processing section 30 and a process of transmitting the encoding result data from the codec processing section 30 to the main memory 22 in a pipelining manner.

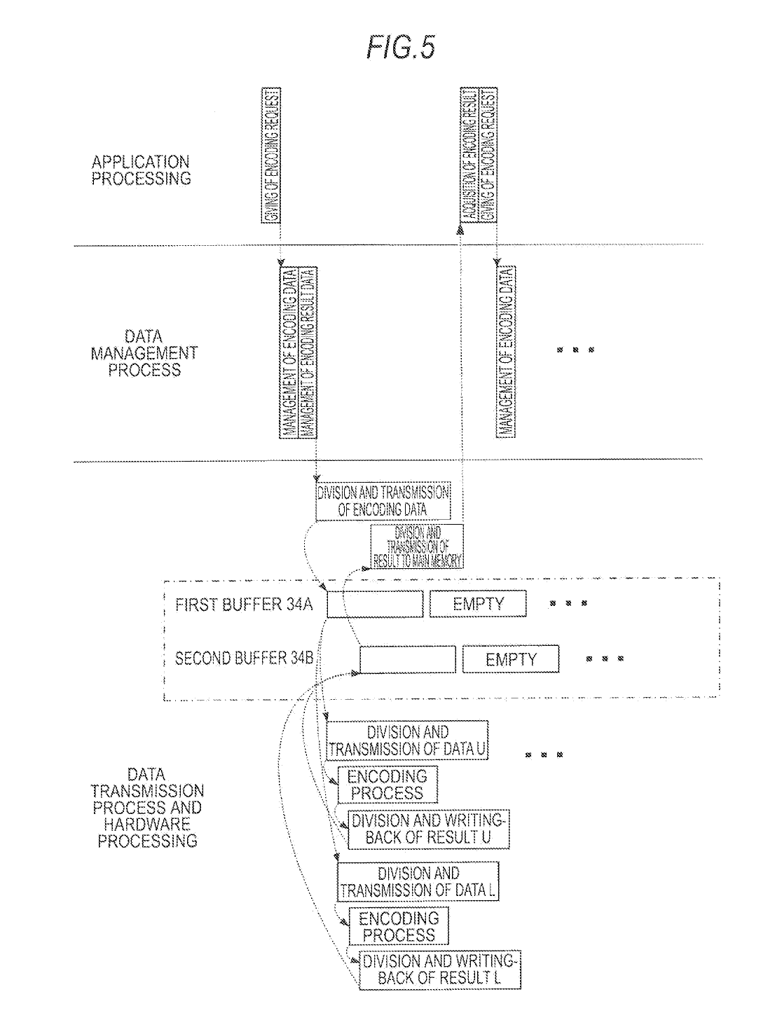

FIG. 5 is a diagram illustrating pipeline processing when the encoding process is performed. The application 101 operating as the main section 20 of the information processing apparatus 10 provides a first buffer 22A used to store the encoding image data in the main memory 22 and a second buffer 22B used to store the encoding result data in the main memory 22 and issues the encoding request.

When the encoding request is issued, the device driver 105 manages the encoding image data and the encoding result data. When the device driver 105 manages the encoding image data, the device driver 105 generates a first buffer list in which a pointer indicating the position of the first buffer 22A of the main memory 22 provided to store the encoding image data is described. In the first buffer list, a transmission unit in accordance with the data transmission process of the codec processing section 30 is set. For example, the transmission unit is set as a unit in which the data is easily transmitted by the pipeline processing of the codec processing section 30. The transmission unit is a unit which is suitable when the encoding image data of each divided screen is supplied to each codec processor 35 or a unit which is suitable for the encoding process of each codec processor 35. For example, an amount of data corresponding to one divided screen is set to an integral multiple of the transmission unit and an amount of data of the transmission unit is set to an integral multiple of the processing unit of the encoding process.

For example, the screen is divided so as to have a size of an integral multiple of the processing unit of the encoding process and the encoding process can be performed for each divided screen. When the size of the final divided screen is not an integral multiple of the processing unit, invalid data is added so as to perform the encoding process.

When the device driver 105 manages the encoding result data, the device driver 105 generates a second buffer list in which a pointer indicating the position of the second buffer 22B provided to store the encoding result data is described. In the second buffer list, a transmission unit is set which is suitable for the data transmission process of the codec processing section 30 by the pipeline processing. For example, the transmission unit is set as a unit in which the data is easily transmitted by the pipeline processing of the codec processing section 30. Moreover, since the encoding result data is data with a variable length, the transmission unit is set so that transmission efficiency is improved by reducing the amount of the invalid data added to allow the amount of data to be formed in the transmission unit when the encoding result data ends.

The device driver 105 allows list information used to acquire the first and second buffer lists and screen division information used for the plurality of codec processors 35 to perform the encoding process for each divided screen to be included in the encoding request and outputs the encoding request to the codec processing section 30.

The local CPU 31 of the codec processing section 30 controls the DMAC 33 based on the list information and performs the DMA transmission on the encoding image data from the first buffer 22A of the main memory 22 to the codec memory 34. In the codec memory 34, a first buffer 34A used to store the encoding image data and a second buffer 34B used to store the encoding result data are disposed. Accordingly, the DMAC 33 stores the encoding image data in the first buffer 34A.

The local CPU 31 controls the codec memory 34 or the codec processors 35 based on the screen division information and distributes the encoding image data for the divided screens stored in the first buffer 34A to the plurality of codec processors 35. For example, the screen is divided into upper and lower screens in FIG. 5. Then, the encoding image data for the upper divided screens is distributed to the codec processor 35-1 and the encoding image data for the lower divided screen is distributed to the codec processor 35-2. The encoding image data stored in the first buffer 34A are sequentially supplied to the codec processors 35-1 and 35-2, and then the encoding process is started before the transmission of the encoding image data from the main memory 22 ends.

When the encoding image data are transmitted from the main memory 22, the image data for the upper and lower divided screens may be read by switching these image data every predetermined number of lines. For example, the image data are read by switching the image data every number of lines which is an integral multiple of the processing unit of the encoding process. By doing so, the encoding process on the upper and lower divided screens can be performed in parallel.

The codec processors 35-1 and 35-2 each perform the encoding process on the distributed encoding image data. The codec processors 35-1 and 35-2 stores the encoding result data obtained through the encoding process for each of the divided screens in the second buffer 34B of the codec memory 34.

The local CPU 31 of the codec processing section 30 controls the DMAC 33 based on the list information and transmits the encoding result data from the second buffer 34B of the codec memory 34 to the main memory 22 of the main section 20. Moreover, the codec processing section 30 controls the transmission order of the encoding result data based on the screen division information and stores the encoding result data to the main memory 22 of the main section 20 in an appropriate order of the divided screens.

In this way, when the encoding image data or the encoding result data are transmitted in an appropriate transmission unit in the pipelining manner in the codec processing section 30, processing in response to the encoding request can be performed at high speed. Moreover, since the encoding process is performed in a division screen unit in parallel, a time necessary for the encoding process is shortened. Accordingly, the encoding process can be performed at a lesser latency time. Therefore, since it is not necessary to queue the encoding requests, there is no problem with cancellation and no problem in which many buffers are necessary to queue the encoding requests.

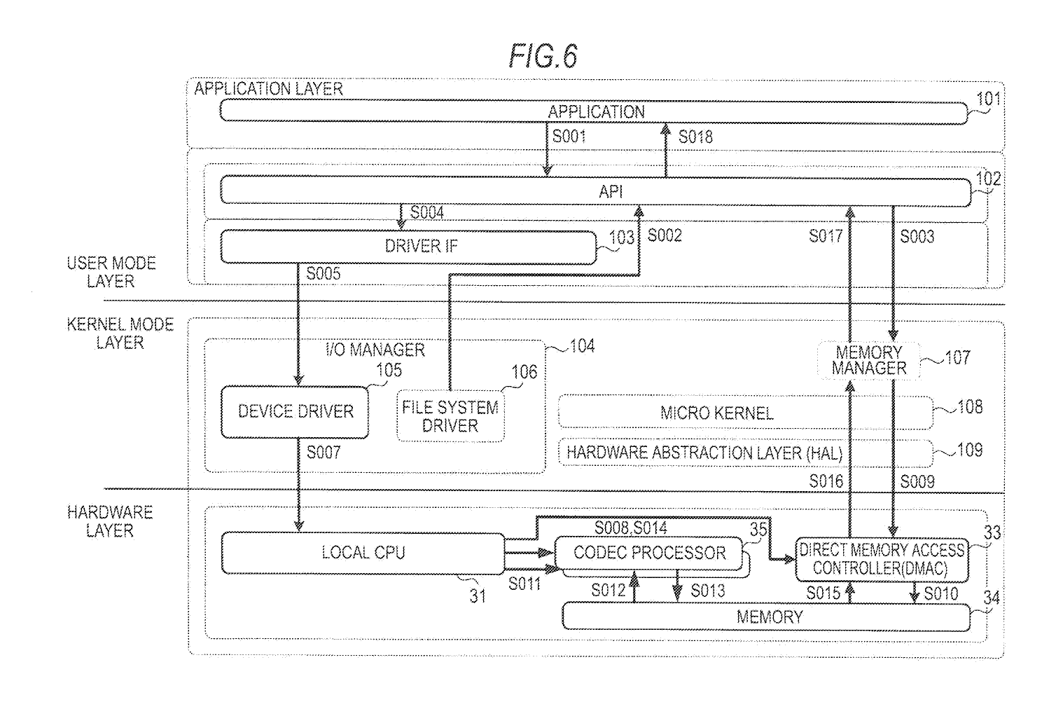

FIG. 6 is a diagram illustrating the flow of the processing of the operating system and the codec processing section 30 when the encoding process is performed. The application 101 operated in the main section 20 of the information processing apparatus 10 issues an encoding request to the API 102 (S001).

The API 102 acquires the encoding image data to be encoded from the HDD 15 by the file system driver 106 (S002).

The API 102 copies the encoding image data to the main memory 22 by the memory manager 107 (S003).

The API 102 acquires buffer information indicating the positions (addresses) and sizes of the first buffer 22A of the main memory 22 used to store the encoding image data and the second buffer 22B of the main memory 22 used to store the encoding result data. The API 102 issues the encoding request including the buffer information to the driver interface 103 (S004).

The driver interface 103 issues the encoding request from the API 102 to the device driver 105 (S005).

The device driver 105 acquires a scatter gather list (SGL) indicating the first buffer 22A and the second buffer 22B of the main memory 22 from the I/O manager 104. Moreover, the device driver 105 re-lists the scatter gather list in a transmission unit in accordance with the data transmission process, as described above, and generates the first and second buffer lists. The I/O manager 104 generates the scatter gather list based on the buffer information included in the encoding request from the driver interface 103.

The device driver 105 stores the generated first and second buffer lists in the main memory 22 and allows the list information indicating the positions (addresses) and sizes of the first and second buffer lists to be included in the encoding request. Moreover, the device driver 105 also allows division information used for the plurality of codec processors 35 to perform the encoding process for each divided screen to be included in the encoding request. The device driver 105 outputs the encoding request including the list information and the division information to the local CPU 31 of the codec processing section 30 (S007).

The local CPU 31 of the codec processing section 30 controls the DMAC 33 based on the list information given from the device driver 105. The DMAC 33 transmits the encoding image data from the first buffer 22A of the main memory 22 to the first buffer 34A of the codec memory 34 of the codec processing section 30 (S008, S009, and S010).

The local CPU 31 allows the sequentially corresponding codec processors 35 to encode the encoding image data stored in the first buffer 34A of the codec memory 34 (S011 and S012).

The codec processors 35 encode the encoding image data and store the encoding result data in the area corresponding to the second buffer 34B of the codec memory 34 (S013).

The local CPU 31 controls the DMAC 33 based on the list information given from the device driver 105. The DMAC 33 performs the DMA transmission on the encoding result data for each of the divided screens subjected to the encoding process from the second buffer 34B of the codec memory 34 to the second buffer 22B of the main memory 22 (S014, S015, and S016).

The API 102 gives an encoding result response, which indicates that the processing for the encoding request ends, to the application 101, when the transmission of the encoding result data ends (S017 and S018).

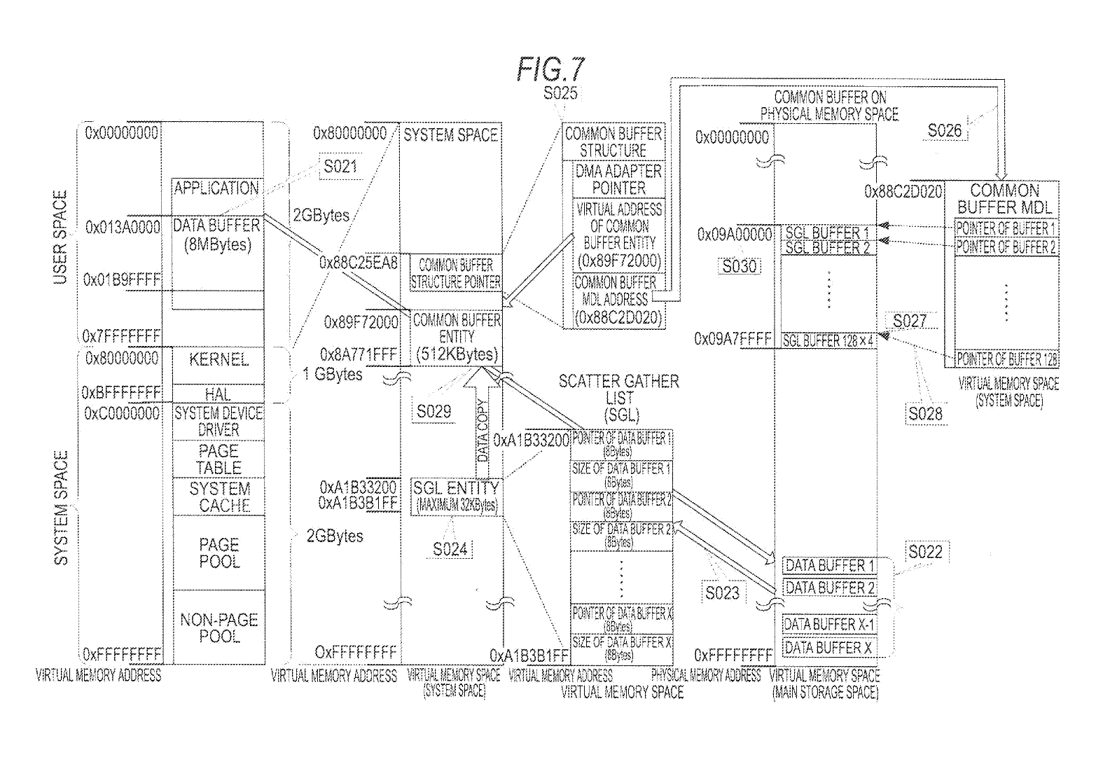

Next, the scatter gather list, the buffer list, and the list information will be described with reference to FIG. 7. In FIG. 7, address values are exemplified to facilitate understanding of the processing. However, the address values are not limited to the values exemplified in FIG. 7.

In the operating system operated in the information processing apparatus 10, there is used a method of mapping addresses (physical addresses) on the main memory 22 to addresses of a virtual memory space.

Since an address space (application area) storing a program managed in the operating system is small, a part of the addresses of programs which are not used as the virtual memory space is saved in a physical memory space. Moreover, various kinds of data can be scattered and stored in the physical memory space and continuous memory areas ensured in the virtual memory space are scattered in the physical memory spaces and are addressed as long as a special work is not done in the physical memory space. For example, when an application stores data in the main memory 22, the data areas of the continuous addresses are set on the virtual memory space, so that the memory manager 107 sets the data storage areas scattered in the minimum unit (for example, 4 KB) in the physical memory space.

The application 101 does not directly access the physical memory space and controls data using the addresses of the virtual memory spaces in order to perform control in continuous addresses. Moreover, the addresses on the physical memory space can be accessed from the codec processing section 30. Furthermore, the addresses of the physical memory spaces can be acquired from the device driver 105 operating in the kernel of the operating system, but direct control of the physical memory spaces may not be performed in the device driver. For this reason, the device driver 105 performs control using the addresses of the virtual memory spaces similarly to the application. Accordingly, the device driver 105 stores the buffer list, in which the virtual memory spaces and the physical memory spaces are associated with each other, on the main memory 22. Moreover, the device driver 105 allows the list information, which indicates the positions or sizes of the physical memory spaces storing the buffer list, to be included in the encoding request and issues the encoding request to the codec processing section 30.

The codec processing section 30 can acquire the buffer list based on the list information. Accordingly, the codec processing section 30 determines where the first buffer 22A or the second buffer 22B disposed based on the buffer list by the application 101 is located in the physical memory spaces, by using the pointer. That is, the codec processing section 30 can perform the DMA transmission on the first buffer 22A or the second buffer 22B by using the pointer.

For example, the data area of a user space is located in the physical space of the main memory 22 (S021). At this time, the memory manager 107 of the operating system locates the data area in, for example, the minimum unit of 4 KB (S022). Accordingly, for example, as shown in FIG. 7, the data area may be scattered and located. A data buffer corresponds to the first buffer 22A used to store the encoding image data or the second buffer 22B used to store the encoding result data.

The device driver 105 issues a request for generating the scatter gather list to the I/O manager 104 and the I/O manager 104 generates the scatter gather list (S023). The generated scatter gather list is written to a system space (S024).

The addresses of the physical memory spaces used in the access from the codec processing section 30 are stored in the scatter gather list. However, since the addresses of the physical memory spaces are written to the virtual memory spaces, the addresses of the physical memory spaces may not be referred by the codec processing section 30. Accordingly, to refer to the scatter gather list from the codec processing section 30, the device driver 105 issues a request for generating a common buffer, which can be referred in both of the main section 20 and the codec processing section 30, to the I/O manager 104. The I/O manager 104 locates the common buffer in the main memory 22 and generates a common buffer structure indicating the common buffer (S025). The common buffer is located as continuous areas so as to read information regarding the common buffer from the codec processing section 30.

The common buffer structure is information used to associate the virtual memory spaces with the physical memory spaces. The common buffer structure has a common buffer MDL (Memory Descriptor List) indicating the virtual addresses of the entities of the common buffers (for example, first and second buffer lists generated by re-listing the scatter gather list) and the addresses of the common buffers on the physical memory space (S026).

The common buffer MDL indicates the pointers of the physical memory spaces in which the entities of the common buffers are continuously stored (S027). Since the pointers of the common buffer MDL indicate the addresses of the physical memory spaces, the entities of the common buffers can be read from the codec processing section 30 by using information regarding the positions of the pointers described in the common buffer MDL (S028).

In regard to the common buffer structure generated in this way, the device driver 105 generates a buffer list by re-listing the scatter gather list in the transmission unit in accordance with the data transmission in the codec processing section 30 and sets the buffer list as the entities of the common buffers. For example, when the transmission unit suitable for the transmission of the encoding image data in the codec processing section 30 is 1 KB, the scatter gather list of the first buffer 22A generated in a unit of 4 KB is re-listed in a unit of 1 KB and is set as the first buffer list. In this way, the first buffer list is generated such that the pointer indicating the position of the first buffer used to store the data before the encoding process is described in the transmission unit in accordance with the data transmission process from the codec processing section 30. For example, when the transmission unit suitable for the transmission of the encoding result data in the codec processing unit 30 is 1 KB, the scatter gather list of the second buffer 22B generated in a unit of 4 KB is re-listed in a unit of 1 KB and is set as the second buffer list. In this way, the second buffer list is generated such that the pointer indicating the position of the second buffer used to store the data after the encoding process is described in the transmission unit in accordance with the data transmission process from the codec processing section 30 (S029).

When the scatter gather list is re-listed and the first and second buffer lists are generated, the entities of the common buffers provided on the physical memory spaces are updated to information regarding the first and second buffer lists. Moreover, the details of the common buffer structures are updated, as the information is updated.

The device driver 105 allows the list information, which indicates the stored position (physical address) and size of the buffer list serving as the re-listed scatter gather list, to be included in the encoding request and issues the encoding request to the codec processing section 30 (S030).

The DMAC 33 of the codec processing section 30 can acquire the first and second buffer lists based on the list information and can transmit the data to the first buffer 22A and the second buffer 22B ensured by the application based on the first and second buffer lists. The first and second buffer lists are set in a transmission unit suitable for the data transmission. Accordingly, when the data are transmitted in a frame unit, it is possible to shorten the transmission processing time by segmenting the generally used DMA processing and the transmission process with the codec processors and continuously performing the transmission process in the pipelining manner.

### [2-2. Encoding Process]

Next, the encoding process performed by the codec processing section 30 will be described. The local CPU 31 of the codec processing section 30 receiving the encoding request acquires the buffer list from the main memory 22 based on the list information. The local CPU 31 determines the position (physical address) of the first buffer 22A on the main memory 22 used to store the encoding image data based on the buffer list. Moreover, the local CPU 31 determines the position (physical address) of the second buffer 22B on the main memory 22 used to store the encoding result data. Based on the determination results, the local CPU 31 controls the DMAC 33 and transmits one frame of the encoding image data from the first buffer 22A of the main memory 22 to the codec memory 34. Moreover, the local CPU 31 distributes the encoding image data to the codec processors 35 based on the division information. Since the buffer list is generated in the transmission unit suitable for the data transmission, the encoding image data is transmitted in the transmission unit suitable for the data transmission.

Each codec processor 35 encodes the encoding image data. The encoding result data obtained through the encoding process has a variable size. Accordingly, the local CPU 31 ensures an area with the same size as the maximum code generation amount in advance in the second buffer 34B of the codec memory 34 for each divided screen when the encoding process is performed on the encoding image data of each divided screen. Each codec processor 35 stores the encoding result data obtained through the encoding process in the area corresponding to the second buffer 34B. In order to transmit the data from the codec processors 35 to the codec memory 34 at high speed, the data are continuously transmitted by burst access (for example, a unit of 256 B). In this case, padding is performed with invalid data (for example, 0 data) having no effect on the decoding process from the final valid encoding result data to the memory boundary address to which the burst access can be gained. Moreover, the encoding result data are initialized with the invalid data having no effect on the decoding process from the final address position stored in the codec memory 34 to the last area ensured in advance.

The DMAC 33 performs the DMA transmission on the encoding result data stored in the second buffer 34B of the codec memory 34 in the transmission unit of the buffer list from the second buffer 34B of the codec memory 34 to the second buffer 22B of the main memory 22.

When the transmission unit is set to have a large transmission size such as 4 KB or an integral multiple of 4 KB in the transmission of the encoding result data, not only the encoding result data but also the invalid data are included in some cases. For this reason, as described above, the device driver 105 re-lists the scatter gather list to generate the buffer list in which the transmission unit is set to be, for example, 1 KB smaller than 4 KB so that many invalid data are not included.

### [2-3. Specific Example of Data Transmission Management]

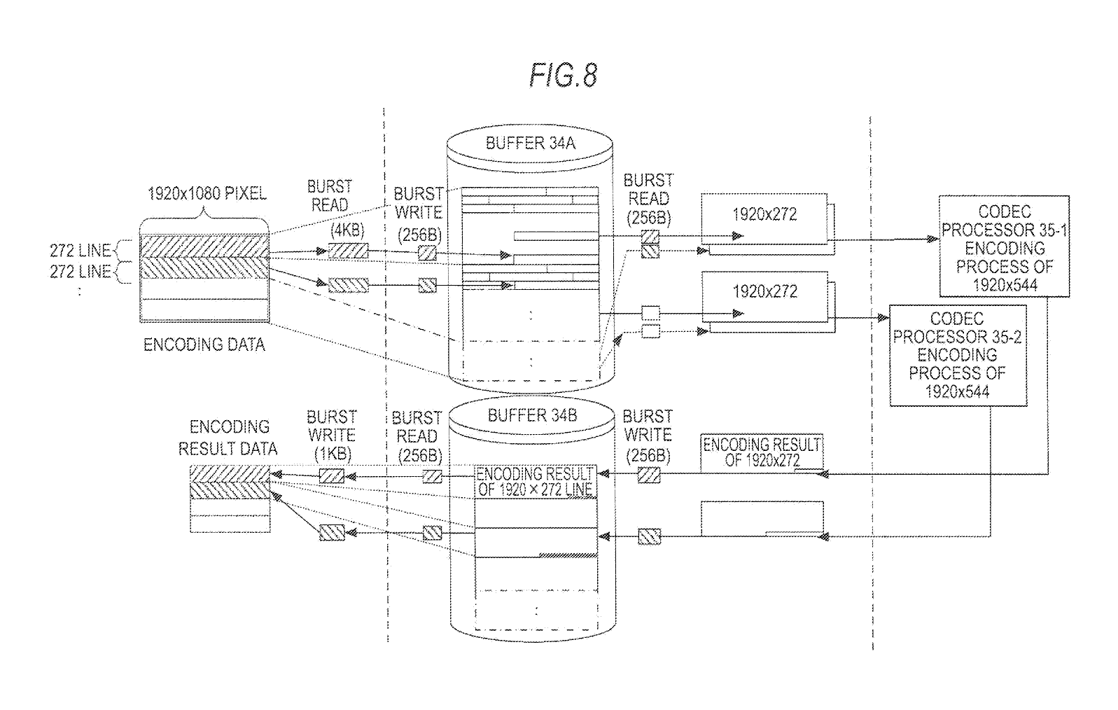

FIG. 8 is a diagram illustrating a specific example of the data transmission management of the codec processing section. One frame of the encoding image data is set to 1920 pixels by 1080 lines. For example, when the codec processor 35 performs the encoding process in a unit of 16 pixels by 16 lines, the codec processor 35 divides a screen for an integral multiple of the 16 lines, for example, for every 272 lines and performs the encoding process for every four divided screens. In the codec processor section 30, the codec processor 35-1 encodes the initial divided screen. In the codec processor section 30, the codec processor 35-2 encodes the second divided screen, the codec processor 35-1 encodes the third divided screen, and the codec processor 35-2 encodes the final divided screen. When one divided screen is set to have 272 lines (which is an integral multiple of the unit of the encoding process), one frame has 1088 lines. Accordingly, the codec processor 35-2 encodes the final divided screen of 264 lines.

The DMAC 33 performs burst reading to read the encoding image data in the unit of 4 KB from the main memory 22 of the main section 20 and to store the read encoding image data in the resistor 33-R. Moreover, the DMAC 33 performs burst writing to the first buffer 34A of the codec memory 34 to store the encoding image data stored in the resister 33-R in a unit of 256 B. The encoding image data is stored in the area corresponding to the first buffer 34A for each of the divided screens.

When the encoding image data corresponding to the unit of the encoding process is stored in the first buffer 34A, the burst reading is performed on the stored encoding image data to read the encoding image data in the unit of 256 B and the read encoding image data is supplied to the codec processor 35. For example, the codec processor 35 performs the encoding process in a unit of 16 lines. In this case, when the encoding image data corresponding to 16 lines of the initial divided screen is stored in the area corresponding to the first buffer 34A, the stored encoding image data is encoded by the codec processor 35-1. In addition, when the encoding image data corresponding to 16 lines of the subsequent divided screen is stored in the first buffer 34A, the stored encoding image data is encoded by the codec processor 35-1. The encoding process is performed as follows. Moreover, the encoding image data of the second divided screen is processed in the same manner, so that the encoding image data is encoded by the codec processor 35-2. In addition, the encoding image data of the third divided screen is encoded by the codec processor 35-1 and the encoding image data of the final divided screen is encoded by the codec processor 35-2.

The codec processors 35-1 and 35-2 encode the encoding image data to generate the encoding result data. Moreover, the codec processors 35-1 and 35-2 perform the burst writing on the encoding result data and the results are stored in the second buffer 34B of the codec memory 34 in a unit of 256 B. The encoding result data is stored in the area corresponding to the second buffer 34B for each of the divided screens. Moreover, since the encoding result data is data with a variable size, the area storing no encoding result data is set to an area of the invalid data in the area corresponding to each of the divided screens. In the area provided for each of the divided screens, all of the encoding result data are configured to be stored in the corresponding areas so as to have a size of the maximum code generation amount when the encoding image data corresponding to 272 lines is encoded.

In this way, the data transmission is performed by pipeline processing between the codec memory 34 and the codec processors 35-1 and 35-2, so that the encoding process is performed and the encoding result data are output sequentially.

The DMAC 33 performs the burst reading to read the encoding result data in the unit of 256 B from the second buffer 34B and stores the read encoding result data in the register 33-T. Moreover, the DMAC 33 performs the burst writing to the main memory 22 of the main section 20 to store the encoding result data stored in the register 33-T in the second buffer 22B of the main memory 22 in a unit of 1 KB. The encoding result data is data with a variable size. When the encoding result data is finally transmitted, the invalid data is transmitted in the unit of 1 KB. Moreover, in the codec memory 34, the encoding result data are divided and stored for each screen area. Accordingly, the encoding result data of each of the divided screens can be integrated as continuous data in the main memory 22 by continuously storing the encoding result data of each of the divided screens in the main memory 22.

Moreover, the encoding result data corresponding to 16 lines of the encoding image data which is 1920×1080: 4:2:2 is about 30 KB (16/1088=1/68 in 440 Mbps/30 frames). Therefore, for example, when the divided screen has 16 lines and the transmission unit is set to 4 KB, a ratio of the invalid data of a fractional point having no 4 KB is a ratio of 1/7.5 to the maximum degree. However, when the transmission unit is set to 1 KB, a ratio of the invalid data of a factional point having no 1 KB is a ratio of 1/30 to the maximum degree, thereby reducing the ratio of the invalid data. By enlarging the size of each of the divided screens when the screen is divided (increasing a latency slightly), each of the codec processors 35 performs the encoding process. In this way, when the size of the divided screen is enlarged, the number of divided screens becomes small. Therefore, the invalid data added as the factional number smaller than 1 KB to the encoding result data becomes smaller in amount compared to a case where the division unit is small. Therefore, the ratio of the invalid data can be mostly disregarded.

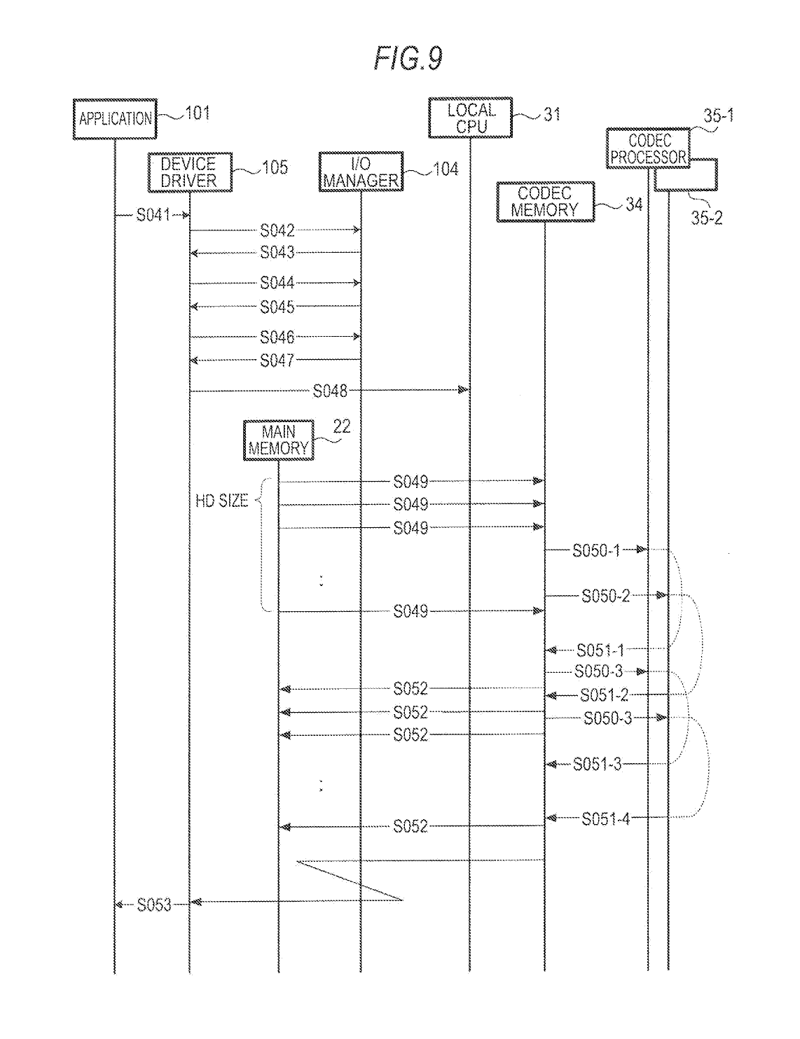

FIG. 9 is a diagram illustrating the control order of the encoding process shown in FIG. 8.

The application 101 issues the encoding request (S041).

When the device driver 105 receives the encoding request, the device driver 105 issues a request for generating the scatter gather lists to the I/O manager 104 (S042).

The I/O manager 104 generates the requested scatter gather lists and notifies the device driver 105 of a generation completion (S043).

After the device driver 105 completely generates the scatter gather lists, the device driver 105 issues a request for generating the common buffers to the I/O manager 104 (S044).

The I/O manager 104 locates the requested common buffers, generates the common buffer structures indicating the common buffers, and notifies the device driver 105 of a generation completion (S045).

The device driver 105 re-lists the scatter gather lists. The device driver 105 re-lists the scatter gather list of the first buffer 22A used to store the encoding image data and the scatter gather list of the second buffer 22B used to store the encoding result data. The device driver 105 re-lists the scatter gather lists in the transmission unit in accordance with the data transmission process from the codec processing section 30, generates the first and second buffer lists, and supplies the first and second buffer lists to the I/O manager 104 (S046).

When the device driver 105 generates the first and second buffer lists, the I/O manager 104 updates the entities of the common buffers provided in the physical memory spaces to the information regarding the first and second buffer lists. Moreover, the I/O manager 104 updates the details of the common buffer structures as the I/O manager 104 updates the entities of the common buffers, and notifies the device driver 105 of a completion (S047).

The device driver 105 allows the list information used to acquire the first and second buffer lists to be included in the encoding request so as to perform the data transmission process from the codec processing section 30 based on the first and second buffer lists stored in the common buffers. Moreover, the device driver 105 allows the division information to be included in the encoding request and issues the encoding request to the local CPU 31 of the codec processing section 30 (S048).

The local CPU 31 allows the DMAC 33 to transmit the encoding image data from the main memory 22 to the codec memory 34 based on the list information. For example, the local CPU 31 reads the buffer lists based on the list information from the main memory 22 and controls the DMAC 33 based on the buffer lists. The DMAC 33 transmits the encoding image data stored in the first buffer 22A of the main memory 22 to the first buffer 34A of the codec memory 34. The buffer list indicates the position of the first buffer 22A used to store the encoding image data in the transmission unit suitable for the data transmission. Accordingly, the DMAC 33 can transmit the encoding image data in the optimum transmission unit at high speed by the pipeline processing (S049).

The local CPU 31 controls the codec processor 35-1 or the codec memory 34 based on the division information to encode the initial divided screen. For example, the codec processor 35-1 encodes the encoding image data of the initial divided screen, whenever the encoding image data of the initial divided screen is stored by 16 lines (the unit of the encoding process) in the first buffer 34A of the codec memory 34 (S050-1). Moreover, the codec processor 35-1 stores the encoding result data obtained through the encoding process in the area corresponding to the second buffer 34B of the codec memory 34 (S051-1).

The local CPU 31 controls the codec processor 35-2 or the codec memory 34 based on the division information to encode the second divided screen. For example, the codec processor 35-2 encodes the encoding image data of the second divided screen, whenever the encoding image data of the second divided screen is stored by 16 lines (the unit of the encoding process) in the first buffer 34A of the codec memory 34 (S050-2). Moreover, the codec processor 35-2 stores the encoding result data obtained through the encoding process in the area corresponding to the second buffer 34B of the codec memory 34 (S051-2).

The local CPU 31 controls the codec processor 35-1 or the codec memory 34 based on the division information to encode the third divided screen after the encoding process on the initial divided screen ends. For example, the codec processor 35-1 performs the encoding process using the encoding image data of the third divided screen stored in the first buffer 34A of the codec memory 34 (S050-3). Moreover, the codec processor 35-1 stores the encoding result data obtained through the encoding process in the area corresponding to the second buffer 34B of the codec memory 34 (S051-3).

The local CPU 31 controls the codec processor 35-2 or the codec memory 34 based on the division information to encode the final divided screen after the encoding process on the second divided screen ends. For example, the codec processor 35-2 performs the encoding process using the encoding image data of the final divided screen stored in the first buffer 34A of the codec memory 34 (S050-4). Moreover, the codec processor 35-2 stores the encoding result data obtained through the encoding process in the area corresponding to the second buffer 34B of the codec memory 34 (S051-4).

The local CPU 31 allows the DMAC 33 to transmit the encoding result data from the codec memory 34 to the main memory 22 based on the list information. That is, the local CPU 31 and the DMAC 33 transmits the encoding result data stored in the second buffer 34B of the codec memory 34 to the second buffer 22B of the main memory 22 based on the buffer list. The buffer list indicates the position of the second buffer 22B used to store the encoding result data in the transmission unit suitable for the data transmission. Accordingly, the DMAC 33 can transmit the encoding image data in the optimum transmission unit at high speed by the pipeline processing (S052).

The local CPU 31 notifies the device driver 105 of an encoding completion notification indicating the end of the encoding process. When the device driver 105 receives the encoding completion notification, the device driver 105 releases the common buffer and returns the encoding completion notification to the API 102 to end the encoding process (S053).

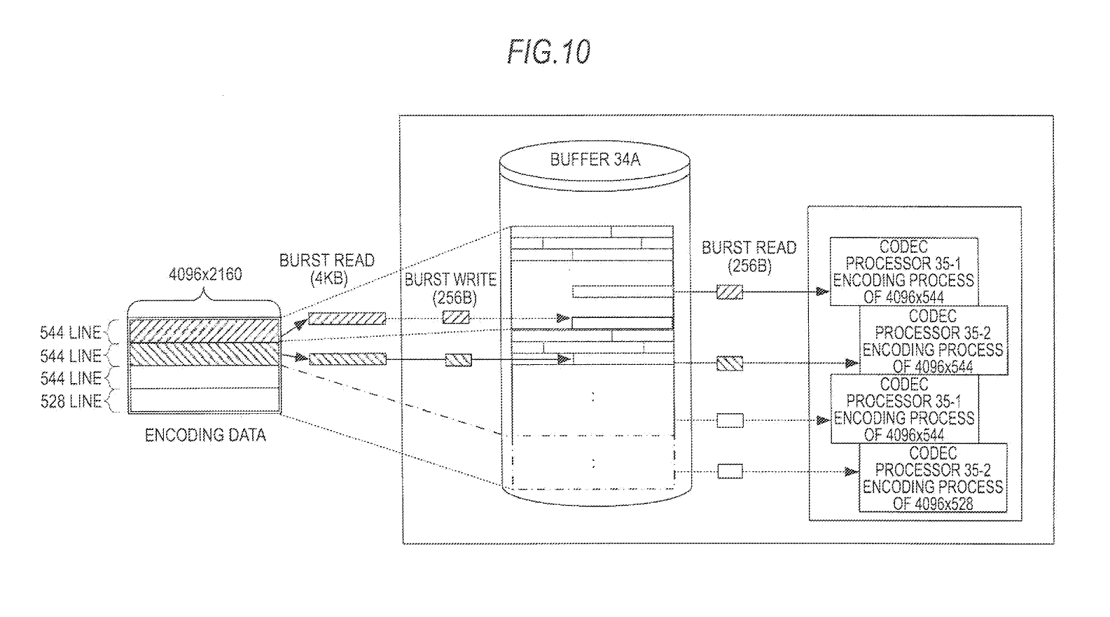

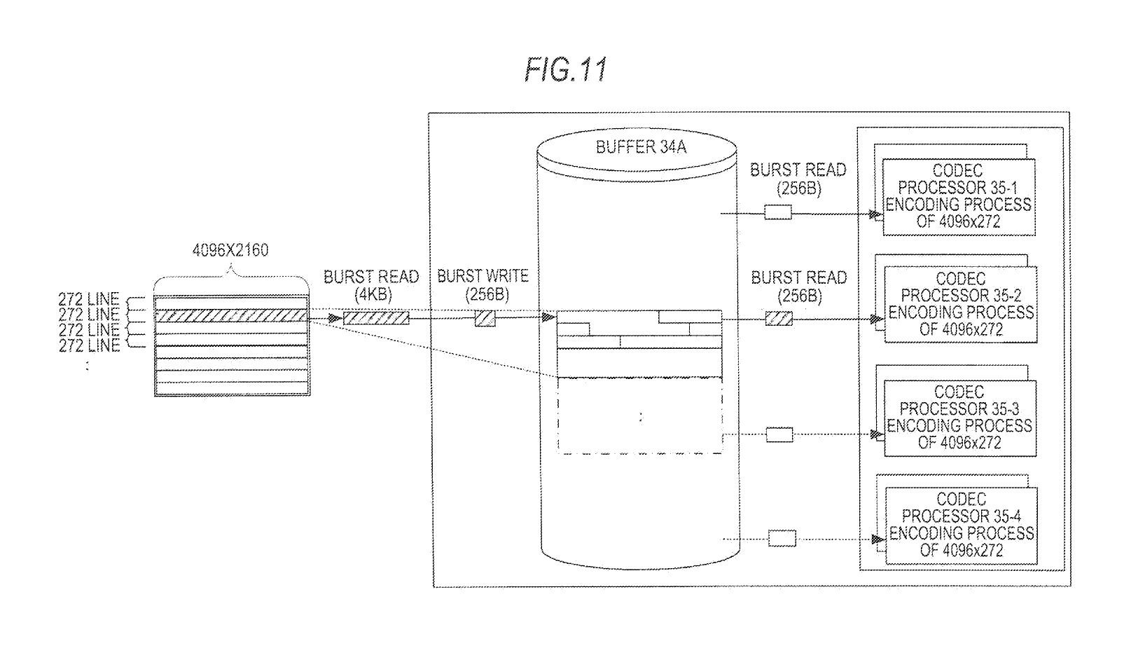

In FIG. 8, the codec processors 35-1 and 35-2 encode the encoding image data corresponding to one screen. However, the number of codec processors may be provided as the number of divided screens and the codec processors may perform the encoding process on different divided screens, respectively. As shown in FIGS. 10 and 11, as in the case of the HD size (1920 pixels by 1080 lines), the same processing can be performed on encoding image data with a 4 K size (4096 pixels by 2160 lines).

### [2-4. Specific Example of Data Transmission Management]

FIG. 10 is a diagram illustrating a case where a screen with a 4 K size is divided into four divided screens for every 544 lines from the initial line and the four divided screens are encoded by two codec processors. In this case, the codec processor 35-1 encodes the initial divided screen (screen with 544 lines from 1st to 544th lines) and the second divided screen (screen with 544 lines from 1089th to 1632nd lines). Moreover, the codec processor 35-2 encodes the second divided screen (screen with 544 lines from 545th to 1088th lines) and the final divided screen (screen with 528 lines from 1633rd to 2160th lines).

FIG. 11 is a diagram illustrating a case where a screen with a 4 K size is divided into eight divided screens for every 272 lines from the initial line and the eight divided screens are encoded by four codec processors. In this case, the codec processor 35-1 encodes the initial divided screen (screen with 272 lines from 1st to 272nd lines) and the fifth divided screen (screen with 272 lines from 1089th to 1360th lines). The codec processor 35-2 encodes the second divided screen (screen with 272 lines from 273rd to 544th lines) and the sixth divided screen (screen with 272 lines from 1361st to 1632nd lines). The codec processor 35-3 encodes the third divided screen (screen with 272 lines from 545th to 816th lines) and the seventh divided screen (screen with 272 lines from 1633rd to 1904th lines). The codec processor 35-4 encodes the fourth divided screen (screen with 272 lines from 817th to 1088th lines) and the final divided screen (screen with 256 lines from 1905th to 2160th lines).

By dividing the screen in this manner and allowing the plurality of codec processors to perform the encoding process, the encoding image data with the HD size can be encoded as in the case where the encoding image data have the 4 K size.

According to the first embodiment, the codec instruction section generates the first and second buffer lists in which the pointers indicating the position of the first buffer 22A used to store the data before the encoding process and the position of the second buffer 22B used to store the data after the encoding process are described in the transmission unit in accordance with the data transmission process. Moreover, the list information used to acquire the first and second buffer lists can be included in the encoding request issued from the codec instruction unit. The codec processing section acquires the first and second buffer lists based on the list information included in the encoding request. The codec processing section transmits the data by the pipeline processing based on the acquired buffer lists, and reads the data before the encoding process from the first buffer 22A or writes the data after the encoding process to the second buffer 22B. Accordingly, it is possible to shorten the time necessary to obtain the encoding result in response to the encoding request from the encoding request. Moreover, it is possible to realize the encoding process with ease without preparing a complex queuing structure. By eliminating the queuing structure, no cancellation mechanism is necessary. Furthermore, since the capacity of the memory of the main memory 22 and the codec processing section 30 can be reduced, no management of the plurality of buffers is necessary. The encoding process is easily realized by a plurality of tracks.

Since the data before the encoding process read from the first buffer 22A is distributed to the plurality of codec processors and is subjected to the encoding process, the time necessary for the encoding process becomes short. Therefore, for example, the encoding result can be obtained in real time. For example, the transmission unit of the first buffer list is set to the unit of the amount data suitable for the distribution and the encoding process of the codec processing section. Moreover, the transmission unit of the second buffer list is determined so that the amount of the invalid data added to the encoding data to allow the data to have the data amount of the transmission unit is small. Accordingly, it is possible to efficiently realize the data transmission by the pipeline processing.

The data transmission between the codec memory 34 and the codec processors 35-1 and 35-2 is performed by the pipeline processing and the encoding process or the like is performed in sequence. Accordingly, it is possible to shorten the time necessary to obtain the encoding result data after reading the encoding image data.

When the screen division information is included in the encoding request, the image before the encoding process is distributed to the plurality of codec processors for each of the divided screens based on the screen division information. Moreover, the area storing the encoding data for each of the divided screens is set in the codec memory and each area is set as the size of the maximum encoding generation amount. Accordingly, even when the encoding process is performed for each of the divided screens, the encoded data can be stored in the codec memory and can be correctly transmitted from the codec memory to the second buffer 22B.

### 3. Second Embodiment

Next, a decoding process will be described in which the main section 20 serving as the codec instruction section issues a decoding request as the codec request and the codec processing section 30 decodes decoding data stored in the main memory 22 of the main section 20 according to a second embodiment. The decoding process will be described when the image data (decoding result image data) after the decoding process is stored in the main memory 22 and is output to an external apparatus. The decoding data is assumed to be encoded data obtained by encoding each frame in an intra-prediction mode.

### [3-1. Data Transmission of Decoding Process]

In the information processing apparatus 10, the data transmission process is performed by the codec processing section 30 in order to efficiently perform the data transmission between the main section 20 and the codec processing section 30. The codec processing section 30 performs a process of transmitting the decoding data from the main memory 22 of the main section 20 to the codec processing section 30 and a process of transmitting the decoding result image data from the codec processing section 30 to the main memory 22 in a pipelining manner.

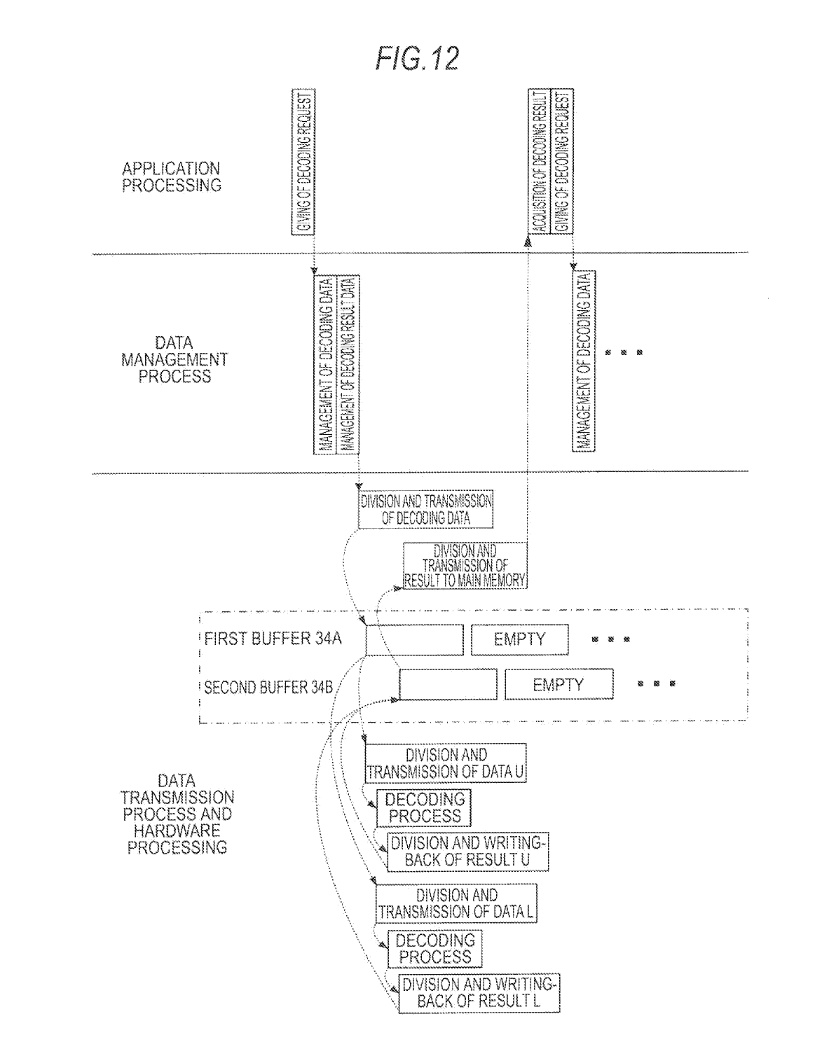

FIG. 12 is a diagram illustrating pipeline processing when the decoding process is performed. The application 101 operated by the main section 20 of the information processing apparatus 10 locates the first buffer 22A used to store the decoding data in the main memory 22 and the second buffer 22B used to store the decoding result image data in the main memory 22 and issues the decoding request.

When the decoding request is issued, the device driver 105 manages the decoding data and the decoding result image data. When the device driver 105 manages the decoding data, the device driver 105 generates a first buffer list in which a pointer indicating the position of the first buffer 22A of the main memory 22 provided to store the decoding data is described. In the first buffer list, a transmission unit in accordance with the data transmission process of the codec processing section 30 is set. For example, the transmission unit is set as a unit in which the data is easily transmitted by the pipeline processing of the codec processing section 30.

When the device driver 105 manages the decoding result image data, the device driver 105 generates a second buffer list in which a pointer indicating the position of the second buffer 22B provided to store the encoding result data is described. In the second buffer list, a transmission unit suitable for the data transmission process of the codec processing section 30 by the pipeline processing is set. For example, the transmission unit is set as a unit in which the data is easily transmitted by the pipeline processing of the codec processing section 30. Moreover, when the image data is output for each of the divided screens by a plurality of substrates installed in the codec processing section 30, the transmission unit is set as a unit of a data amount suitable for transmission of the image data for each of the divided screens. For example, the data amount of one divided screen is set so as to be an integral multiple of the transmission unit.

The device driver 105 allows list information used to acquire the first and second buffer lists to be included in the decoding request and outputs the decoding request to the codec processing section 30.

The local CPU 31 of the codec processing section 30 controls the DMAC 33 based on the list information and performs the DMA transmission on the decoding data from the first buffer 22A of the main memory 22 to the codec memory 34. In the codec memory 34, the first buffer 34A used to store the decoding data and the second buffer 34B used to store the decoding result image data are disposed. Accordingly, the DMAC 33 stores the decoding data in the first buffer 34A.

The local CPU 31 analyzes the decoding data and segments the decoding data. For example, the local CPU 31 acquires image size information included in the decoding data or macro block information or the like indicating the size or the like of a macro block and specifies the head position of a line based on such information. Moreover, the local CPU 31 segments the decoding data for each divided screen with a predetermined number of lines. The division position is determined so that the boundary of burst transmission becomes the division position in consideration of the position of the boundary when the decoding result image data is transmitted to the codec memory 34 through the burst transmission. The local CPU 31 manages a data transmission amount and the division position of the decoding data and distributes the necessary decoding data from the codec memory 34 to the plurality of codec processors 35 in accordance with the divided screen to be actually decoded. In FIG. 12, data U indicates data of an upper divided screen and data L indicates data of a lower divided screen.

The codec processors 35-1 and 35-2 each perform the decoding process on the distributed decoding data. The codec processors 35-1 and 35-2 store the decoding result image data obtained through the decoding process for each of the divided screens in the second buffer 34B of the codec memory 34. Areas mapped in accordance with the image sizes of the divided screens are ensured in advance in the second buffer 34B and the codec processors 35-1 and 35-2 stores the decoding result image data in the areas corresponding to the divided screens.

The local CPU 31 of the codec processing section 30 controls the DMAC 33 based on the list information and transmits the decoding result image data from the second buffer 34B of the codec memory 34 to the main memory 22 of the main section 20. Moreover, the codec processing section 30 controls the transmission order of the decoding result image data in the order of the divided screens and stores the decoding result image data in the main memory 22 of the main section 20 in an appropriate order of the divided screens.

In this way, when the decoding data or the decoding result image data are transmitted in an appropriate transmission unit in the pipelining manner in the codec processing section 30, processing in response to the decoding request can be performed at high speed. Moreover, since the decoding process is performed in a division screen unit in parallel, a time necessary for the decoding process is shortened. Accordingly, the decoding process can be performed at a lesser latency time. Therefore, since it is not necessary to queue the decoding requests, there is no problem with cancellation and no problem that many buffers are necessary to queue the decoding requests.

The dividing of the decoding data is performed so as to correspond to a transmission format when the decoding result image data is output to an external apparatus. The outputting of the decoding result image data is performed so as to display an image appropriately subjected to the decoding in accordance with the external apparatus.

For example, a screen with a 4 K size is divided so as to correspond to HD-SDI transmission (transmission of data with an HD size per SDI) and the decoding data of the divided screen is decoded by each of the plurality of codec processors 35. The decoding result image data generated by the plurality of codec processors 35 and stored in the second buffer 34B are output in accordance with a display process of the external apparatus.

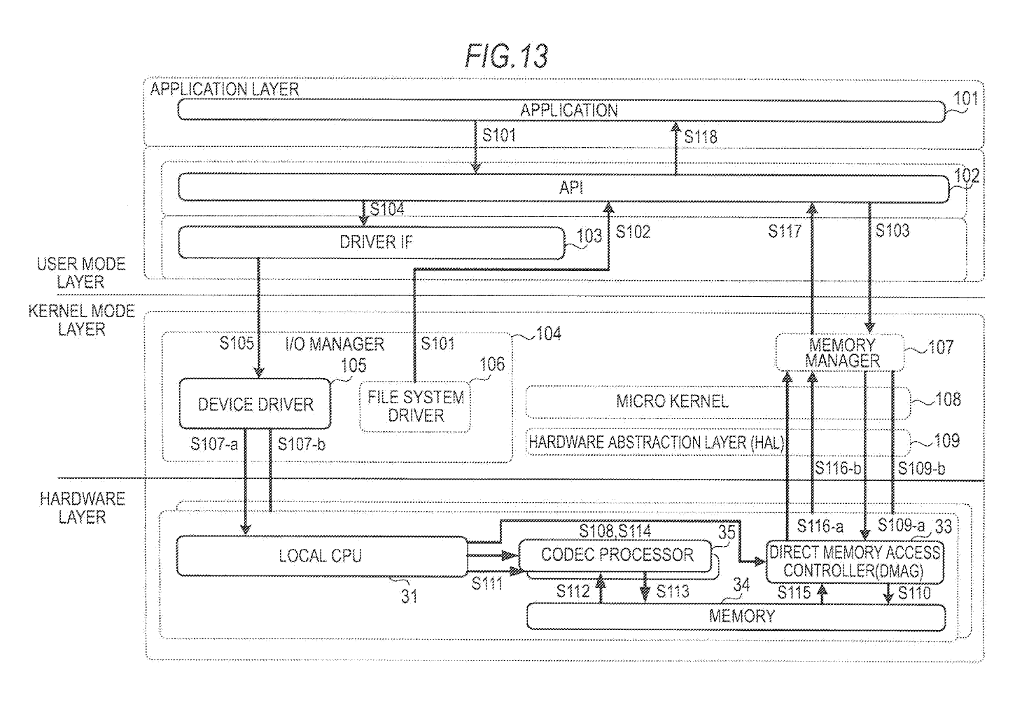

FIG. 13 is a diagram illustrating the flow of the processing of the operating system and the codec processing section 30 when the decoding process is performed. The application 101 operated in the main section 20 of the information processing apparatus 10 issues a decoding request to the API 102 (S101).

The API 102 acquires the decoding data to be decoded from the HDD 15 by the file system driver 106 (S102).

The API 102 copies the decoding data to the main memory 22 by the memory manager 107 (S103).

The API 102 acquires buffer information indicating the positions (addresses) and sizes of the first buffer 22A of the main memory 22 used to store the decoding data and the second buffer 22B of the main memory 22 used to store the decoding result image data. The API 102 issues the decoding request including the buffer information to the driver interface 103 (S104).

The driver interface 103 issues the decoding request from the API 102 to the device driver 105 (S105).

The device driver 105 acquires a scatter gather list indicating the first buffer 22A and the second buffer 22B of the main memory 22 from the I/O manager 104. Moreover, the device driver 105 generates the first and second buffer lists by re-listing the scatter gather list in a suitable transmission unit, as described above. The I/O manager 104 generates the scatter gather list based on the buffer information included in the decoding request from the driver interface 103.

The device driver 105 stores the generated first and second buffer lists in the main memory 22 and allows the list information indicating the positions (addresses) and sizes of the first and second buffer lists to be included in the decoding request. The device driver 105 outputs the decoding request including the list information to the local CPUs 31 of the codec processing sections 30 of two substrates PA and PB (S107-a and S107-b).

The local CPU 31 of the codec processing section 30 of the substrate PA controls the DMAC 33 based on the list information given from the device driver 105. The DMAC 33 transmits the decoding data from the first buffer 22A of the main memory 22 to the first buffer 34A of the codec memory 34 of the codec processing section 30 (S108, S109-a, and S110).

The local CPU 31 analyzes the decoding data and determines the division position. Moreover, the local CPU 31 allows the corresponding codec processors 35 to decode the decoding data divided at the determined division position (S111 and S112).

The codec processors 35 decode the decoding data and store the decoding result image data in the area corresponding to the second buffer 34B of the codec memory 34 (S113).

The local CPU 31 controls the DMAC 33 based on the list information given from the device driver 105. The DMAC 33 performs the DMA transmission on the decoding result image data for each of the divided images subjected to the decoding process from the second buffer 34B of the codec memory 34 to the second buffer 22B of the main memory 22 (S114, 5115, and S116-a).

The codec processing section 30 of the substrate PB performs the same processings as that of the substrate PA (S109-b and S116-b).

In the substrate PB, the decoding process is performed using the decoding data of the divided screens different from those of the substrate PA and the decoding result image data of the divided screens different from those of the substrate PA are generated.

The API 102 gives a decoding result response, which indicates that the processing for the decoding request ends, to the application 101, when the transmission of the decoding result image data ends (S117 and S118).

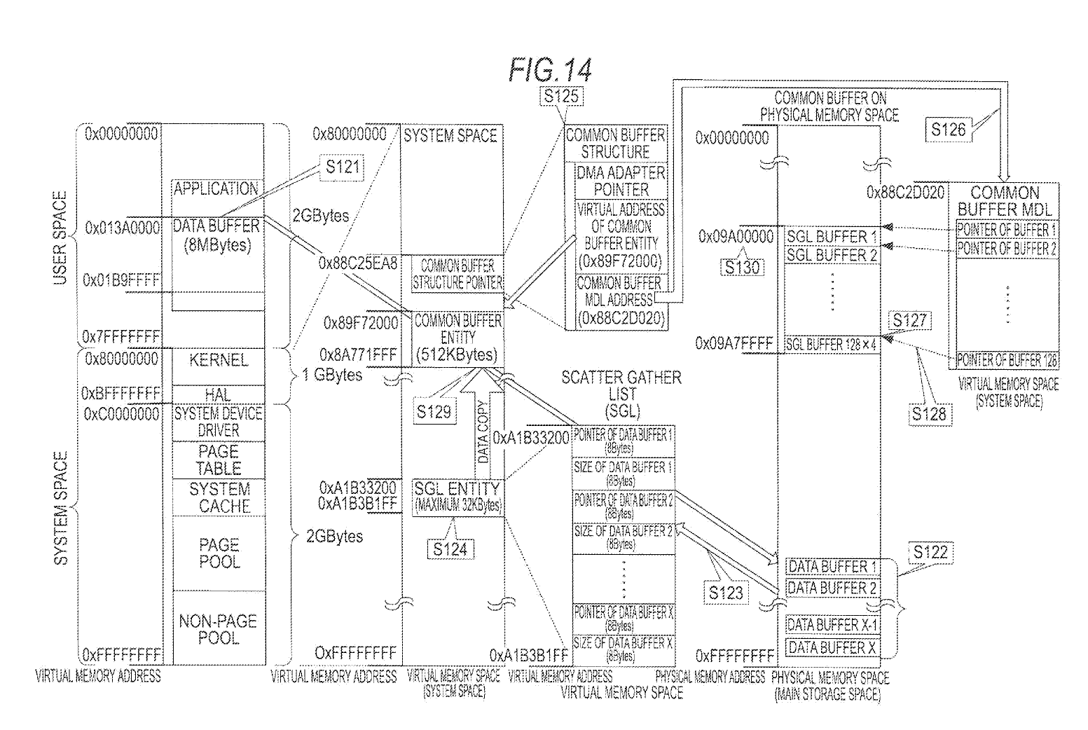

Next, the scatter gather list, the buffer list, and the list information will be described with reference to FIG. 14. In FIG. 14, address values are exemplified to facilitate understanding of the processing. However, the address values are not limited to the values exemplified in FIG. 14.

In the operating system operated in the information processing apparatus 10, as described above, there is used a method of mapping addresses (physical addresses) on the main memory 22 to addresses of a virtual memory space.

Since an address space (application area) storing a program managed in the operating system is small, a part of the addresses of programs which are not used as the virtual memory space are saved in a physical memory space. Moreover, various kinds of data can be scattered and stored in the physical memory space and continuous memory areas ensured in the virtual memory space are scattered in the physical memory spaces and are addressed as long as a special work is not done in the physical memory space. For example, when an application stores data in the main memory 22, the data areas of the continuous addresses are set on the virtual memory space, so that the memory manager 107 sets the data storage areas scattered in the minimum unit (for example, 4 KB) in the physical memory space.

The application 101 does not directly access the physical memory space and controls data using the addresses of the virtual memory spaces in order to perform control in continuous addresses. Moreover, the addresses on the physical memory space can be accessed from the codec processing section 30. Furthermore, the addresses of the physical memory spaces can be acquired from the device driver 105 operating in the kernel of the operating system, but direct control of the physical memory spaces may not be performed in the device driver. For this reason, the device driver 105 performs control using the addresses of the virtual memory spaces like the application. Accordingly, the device driver 105 stores the buffer list, in which the virtual memory spaces and the physical memory spaces are associated with each other, in the main memory 22. Moreover, the device driver 105 allows the list information, which indicates the positions of the physical memory spaces storing the buffer list, to be included in the decoding request and issues the decoding request to the codec processing section 30.

The codec processing section 30 can acquire the buffer list, in which the virtual memory spaces and the physical memory spaces are associated with each other, based on the list information. Accordingly, the codec processing section 30 determines where the first buffer 22A or the second buffer 22B disposed based on the buffer list by the application 101 is located in the physical memory spaces. That is, the codec processing section 30 can perform the DMA transmission on the first buffer 22A or the second buffer 22B by using the pointer.

For example, the data area of a user space is located in the physical space of the main memory 22 (S121). At this time, the memory manager 107 of the operating system locates the data area in, for example, the unit of 4 KB (S122). Accordingly, for example, as shown in FIG. 14, the data area may be scattered and located. A data buffer corresponds to the first buffer 22A used to store the decoding data or the second buffer 22B used to store the decoding result image data.

The device driver 105 issues a request for generating the scatter gather list to the I/O manager 104 and the I/O manager 104 generates the scatter gather list (S123). The generated scatter gather list is written to a system space (S124).

The addresses of the physical memory spaces used in the access from the codec processing section 30 are stored in the scatter gather list. However, since the addresses of the physical memory spaces are written to the virtual memory spaces, the addresses of the physical memory spaces may not be referred to by the codec processing section 30. Accordingly, to refer to the scatter gather list from the codec processing section 30, the device driver 105 issues a request for generating a common buffer, which can be referred in both of the main section 20 and the codec processing section 30, to the I/O manager 104. The I/O manager 104 locates the common buffer in the main memory 22 and generates a common buffer structure indicating the common buffer (S125). The common buffer is located as continuous areas so as to continuously read information regarding the common buffer from the codec processing section 30.

The common buffer structure is information used to associate the virtual memory spaces with the physical memory spaces. The common buffer structure has a common buffer MDL (Memory Descriptor List) indicating the virtual addresses of the entities of the common buffers (for example, first and second buffer lists generated by re-listing the scatter gather list) and the addresses of the common buffers on the physical memory space (S126).

The common buffer MDL indicates the pointers of the physical memory spaces in which the entities of the common buffers are continuously stored (S127). Since the pointers of the common buffer MDL indicate the addresses of the physical memory spaces, the entities of the common buffers can be read from the codec processing section 30 by using information regarding the positions of the pointers described in the common buffer MDL (S128).

In regard to the common buffer structure generated in this way, the device driver 105 generates a buffer list by re-listing the scatter gather list in the transmission unit in accordance with the data transmission in the codec processing section 30 and sets the buffer list as the entities of the common buffers. For example, when the transmission unit suitable for the transmission of the decoding data in the codec processing section 30 is 4 KB, the scatter gather list of the first buffer 22A generated in the unit larger than, for example, 4 KB is re-listed in a unit of 4 KB and is set as the first buffer list. In this way, the first buffer list is generated such that the pointer indicating the position of the first buffer used to store the data before the decoding process is described in the transmission unit in accordance with the data transmission process from the codec processing section 30. For example, when the transmission unit suitable for the transmission of the decoding result image data in the codec processing unit 30 is 1 KB, the scatter gather list of the second buffer 22B generated in the unit of 4 KB is re-listed in a unit of 1 KB and is set as the second buffer list. In this way, the second buffer list is generated such that the pointer indicating the position of the second buffer used to store the data after the decoding process is described in the transmission unit in accordance with the data transmission process from the codec processing section 30 (S129).

When the scatter gather list is re-listed and the first and second buffer lists are generated, the entities of the common buffers provided on the physical memory spaces are updated to information regarding the first and second buffer lists. Moreover, the details of the common buffer structures are updated, as the information is updated.

The device driver 105 allows the list information, which indicates the stored position (physical address) and size of the buffer list serving as the re-listed scatter gather list, to be included in the decoding request and issues the decoding request to the codec processing section 30 (S130).

The DMAC 33 of the codec processing section 30 can acquire the first and second buffer lists based on the list information and can transmit the data to the first buffer 22A and the second buffer 22B ensured by the application based on the first and second buffer lists. The first and second buffer lists are set in a transmission unit suitable for data transmission. Accordingly, when the data are transmitted in a frame unit, it is possible to shorten the transmission processing time by segmenting the generally used DMA processing and the transmission process with the codec processors and continuously performing the transmission process in the pipelining manner.

### [3-2. Decoding Process]

Next, the decoding process performed by the codec processing section 30 will be described. The local CPU 31 of the codec processing section 30 receiving the decoding request acquires the buffer list from the main memory 22 based on the list information. The local CPU 31 determines the position (physical address) of the first buffer 22A on the main memory 22 used to store the decoding data and the position (physical address) of the second buffer 22B on the main memory 22 used to store the decoding data based on the buffer lists. Based on the determination results, the local CPU 31 controls the DMAC 33 and transmits one frame of the decoding data from the first buffer 22A of the main memory 22 to the codec memory 34. Moreover, the local CPU 31 distributes the decoding data to the codec processors 35 by analyzing the decoding data and dividing the decoding data for each of the divided screens. Since the buffer list is generated in the transmission unit suitable for the data transmission, the decoding data is transmitted in the transmission unit suitable for the data transmission.

Each codec processor 35 performs the decoding process using the decoding data. Here, the decoding result image data has a data amount in accordance with the size of the divided screen. Accordingly, the local CPU 31 ensures an area used to store the decoding result image data in the second buffer 34B of the codec memory 34 in advance in accordance with the number of divided screens and the sizes of the divided screens. Each codec processor 35 stores the decoding result image data obtained through the decoding process on the decoding data in the area corresponding to the second buffer 34B. In order to transmit the data from the codec processors 35 to the codec memory 34 at high speed, the data are continuously transmitted by a burst access (for example, a unit of 256 B).

The DMAC 33 performs the DMA transmission on the decoding result image data stored in the second buffer 34B of the codec memory 34 in the transmission unit of the buffer list from the second buffer 34B of the codec memory 34 to the second buffer 22B of the main memory 22.

When the transmission unit is set to have a large transmission size in the transmission of the decoding result image data, the data amount in the ending of the decoding result image data of the divided images may not be the transmission unit, but may have many invalid data. For this reason, as described above, the device driver 105 re-lists the scatter gather list to generate the buffer list in which the transmission unit is set to be, for example, 1 KB which is a small size so that a lot of invalid data are not included.

The decoding result image data from the areas of the respective divided screens in the second buffer 34B of the codec memory 34 are output in parallel from the output unit 36. Thus, the decoding result image data of an image part displayed by the display device can be output to each display device of an external apparatus which displays an image by forming one screen by the plurality of display devices.

### [3-3. Specific Example of Data Transmission Management]

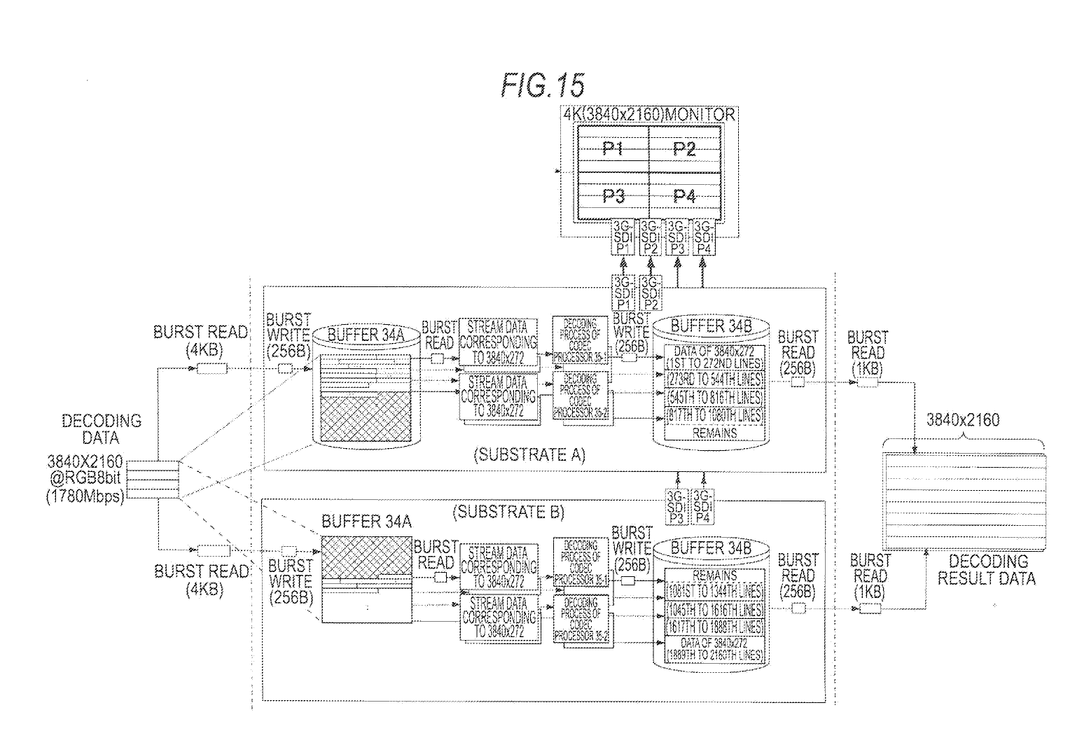

FIG. 15 is a diagram illustrating a specific example of the data transmission management of the codec processing section. One frame of the decoding data is set to 3840 pixels by 2160 lines. Moreover, the decoding data is encoded data subjected to the encoding process in the unit of 16 lines.

The codec processing section 30 of the substrate PA decodes the area corresponding to the upper half of a one frame image and the codec processing section 30 of the substrate PB decodes the area corresponding to the lower half of the one frame image.

The codec processor 35-1 in the codec processing section 30 of the substrate PA decodes the initial divided image (an image corresponding to 272 lines from 1st to 272nd lines (an integral multiple of 16 lines)) in the upper half of the one frame image. Moreover, the codec processor 35-1 decodes the second divided image (an image corresponding to 272 lines from 273rd to 544th lines) in the upper half of the one frame image.

The codec processor 35-2 in the codec processing section 30 of the substrate PA decodes the third divided image (an image corresponding to 272 lines from 545th to 816th lines) in the upper half of the one frame image. Moreover, the codec processor 35-2 decodes the final divided image (an image corresponding to 264 lines from 817th to 1080th lines) in the upper half of the one frame image. In a case where the encoded data is encoded data subjected to the encoding process in the unit of 16 lines, image data with 817th to 1088th lines can be obtained when the final divided image is subjected to the decoding process.

The codec processor 35-1 in the codec processing section 30 of the substrate PB performs the decoding process to decode the initial divided image in the lower half of the one frame image. Here, when the encoded data is encoded data subjected to the encoding process in the unit of 16 lines, the 1081st line which is the initial line of the lower half of the area is included in the encoding processing unit of 1073rd to 1088th lines. Accordingly, in the decoding process on the lower half of the area, the encoded data which is the result obtained by encoding 1073rd to 2160th lines is used. Accordingly, the codec processor 35-1 decodes the initial divided area (an area corresponding to 272 lines from 1073rd to 1344th lines) in the lower half of the one frame image.

Moreover, the codec processor 35-1 decodes the second divided area (an area corresponding to 272 lines from 1345th to 1616th lines) in the lower half of the one frame image.

The codec processor 35-2 in the codec processing section 30 of the substrate PB decodes the third divided area (an area corresponding to 272 lines from 1617th to 1888th lines) in the lower half of the one frame image. Moreover, the codec processor 35-2 decodes the final divided area (an area corresponding to 264 lines from 1889th to 2160th lines) in the lower half of the one frame image.

The DMACs 33 of the substrates PA and PB perform burst reading to read the decoding data in the unit of 4 KB from the main memory 22 of the main section 20 and to store the read decoding data in the resistor 33-R. Moreover, the DMACs 33 perform burst writing to the first buffer 34A of the codec memory 34 to store the decoding data stored in the resister 33-R in a unit of 256 B.

The codec processors 35-1 and 35-2 perform the burst reading on the decoding data stored in the first buffer 34A for each divided screen based on the analysis result of the decoding data to read the decoding data in the unit of 256 B and perform the decoding process. Moreover, the codec processors 35-1 and 35-2 perform the burst writing on the decoding result image data obtained through the decoding process and store the results in the areas corresponding to the divided screens in the second buffer 34B.

In this way, the data transmission is performed by pipeline processing between the codec memory 34 and the codec processors 35-1 and 35-2, so that the decoding process is performed and the decoding result image data are output sequentially.

The DMACs 33 perform the burst reading to read the decoding result image data in the unit of 256 B from the second buffer 34B and stores the read decoding result image data in the register 33-T. Moreover, the DMACs 33 perform the burst writing to the main memory 22 of the main section 20 to store the decoding result image data stored in the register 33-T in the second buffer 22B of the main memory 22 in a unit of 1 KB.

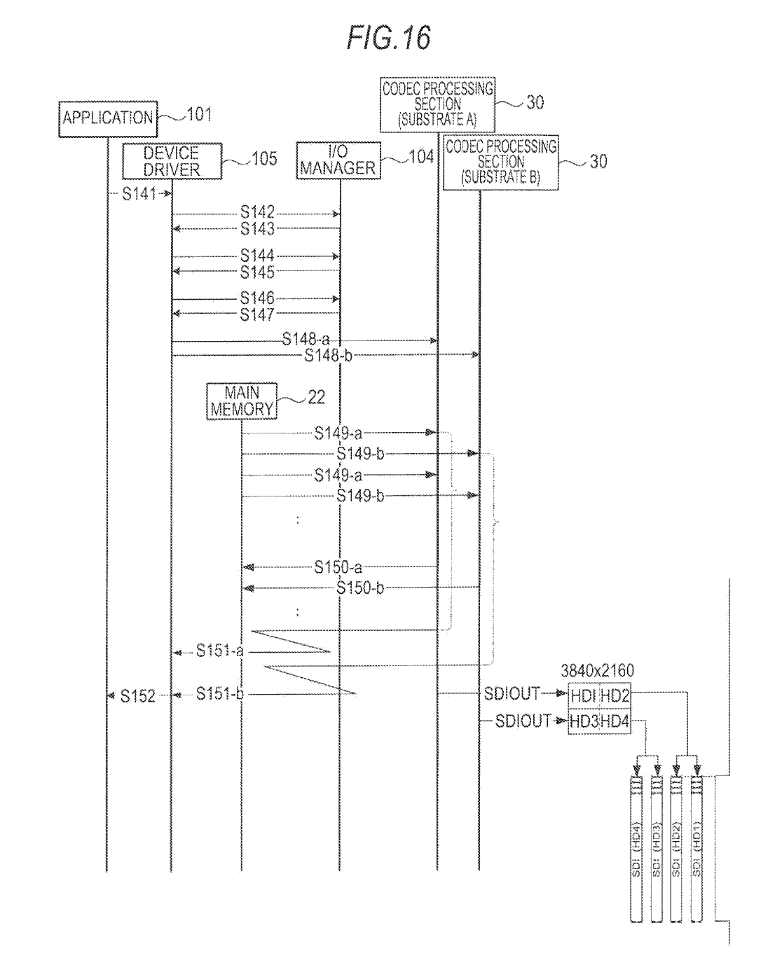

FIG. 16 is a diagram illustrating the control order of the decoding process shown in FIG. 15.

The application 101 issues the decoding request (S141). When the device driver 105 receives the decoding request, the device driver 105 issues a request for generating the scatter gather lists to the I/O manager 104 (S142).

The I/O manager 104 generates the requested scatter gather lists and notifies the device driver 105 of a generation completion (S143).

After the device driver 105 completely generates the scatter gather lists, the device driver 105 issues a request for generating the common buffers to the I/O manager 104 (S144).

The I/O manager 104 locates the requested common buffers, generates the common buffer structures indicating the common buffers, and notifies the device driver 105 of a generation completion (S145).

The device driver 105 re-lists the scatter gather lists. The device driver 105 re-lists the scatter gather list of the first buffer 22A used to store the decoding data and the scatter gather list of the second buffer 22B used to store the decoding result image data. The device driver 105 re-lists the scatter gather lists in the transmission unit in accordance with the data transmission process from the codec processing section 30, generates the first and second buffer lists, and supplies the first and second buffer lists to the I/O manager 104 (S146).

When the device driver 105 generates the first and second buffer lists, the I/O manager 104 updates the entities of the common buffers provided in the physical memory spaces to the information regarding the first and second buffer lists. Moreover, the I/O manager 104 updates the details of the common buffer structures as the I/O manager 104 updates the entities of the common buffers, and notifies the device driver 105 to a completion (S147).

The device driver 105 allows the list information used to acquire the first and second buffer lists to be included in the decoding request so as to perform the data transmission process from the codec processing section 30 based on the first and second buffer lists stored in the common buffers. Moreover, the device driver 105 allows area allocation information, which indicates on which area of the one frame image the decoding process is performed by the substrates PA and PB, to be included in the decoding request and supplies the decoding request to the local CPUs 31 of the substrates PA and PB (S148-a and S148-b).

The local CPUs 31 of the substrates PA and PB each allow the DMAC 33 to transmit the decoding data from the main memory 22 to the codec memory 34 based on the list information or the area allocation information. For example, the local CPUs 31 each read the buffer lists from the main memory 22 based on the list information and controls the DMAC 33 based on the buffer lists. The DMAC 33 transmits the decoding data stored in the first buffer 22A of the main memory 22 to the first buffer 34A of the codec memory 34. The buffer list indicates the position of the first buffer 22A at which the decoding data is stored in the transmission unit suitable for the data transmission. Accordingly, the DMAC 33 can transmit the decoding data in the optimum transmission unit at high speed by the pipeline processing (S149-a and S149-b).

The local CPUs 31 of the substrates PA and PB each perform the decoding process by analyzing the decoding data and distributing the decoding data to the codec processors 35-1 and 35-2 for each of the divided screens based on the analysis result. The codec processors 35-1 and 35-2 stores the decoding result image data obtained through the decoding process in the corresponding areas in the second buffers 34B of the codec memory 34.

The local CPUs 31 of the substrates PA and PB each allow the DMAC 33 to transmit the decoding result image data from the codec memory 34 to the main memory 22 based on the list information. That is, the local CPU 31 and the DMAC 33 transmit the decoding result image data stored in the second buffer 34B of the codec memory 34 to the second buffer 22B of the main memory 22 based on the buffer lists. The buffer list indicates the position of the first buffer 22B at which the decoding result image data is stored in the transmission unit suitable for the data transmission. Accordingly, the DMAC 33 can transmit the decoding result image data in the optimum transmission unit at high speed by the pipeline processing (S150-a and S150-b).

The local CPU 31 of the substrate PA supplies a decoding completion indicating the end of the decoding process to the device driver 105 (S151-a). The local CPU 31 of the substrate PB supplies a decoding completion notification indicating the end of the decoding process to the device driver 105 (S151-b). When the device driver 105 receives the decoding completion notification from the local CPUs 31 of both substrates PA and PB, the device driver 105 completes the decoding process by releasing the common buffers and returning a decoding completion notification to the API 102 (S152).

For example, an image with a 4 K size can be displayed using four display devices HD1 to HD4 with an HD size by reading the decoding result image data from the second buffers 34B of the codec memories 34 of the substrates PA and PB and outputting the decoding result image data in parallel in an SDI manner.

### [3-4. Output Processing of Decoding Result]

Next, a specific example will be described in which the decoding result image data is output from the output unit 36. The decoding data is the data obtained by encoding the image data with a 4 K size (3840 pixels by 2160 lines, 4:4:4). An external apparatus connected to the output unit 36 displays an image with a 4 K size using four display panels with an HD size. Each display panel has two HD-SDI (High Definition Serial Digital Interface) inputs or a dual link HD-SDI input and one 3G-SDI (SMPTE 424M) input.

In the substrate PA, it is necessary to output image data of 1920 pixels by 1080 lines by each of, for example, two 3G-SDI outputs. Likewise, in the substrate PB, it is necessary to output image data of 1920 pixels by 1080 lines by each of, for example, two 3G-SDI outputs. Therefore, in regard with 16 lines (1073rd to 1088th lines) subjected to the decoding process commonly by the substrates PA and PB, the substrate PA decoding the upper half of the one frame area outputs the 1073rd to 1080th lines. Moreover, the substrate PB decoding the lower half of the one frame area outputs 1081st to 1088th lines. That is, the substrates PA and PB each output the image data corresponding to 3840 pixels by 1080 lines.

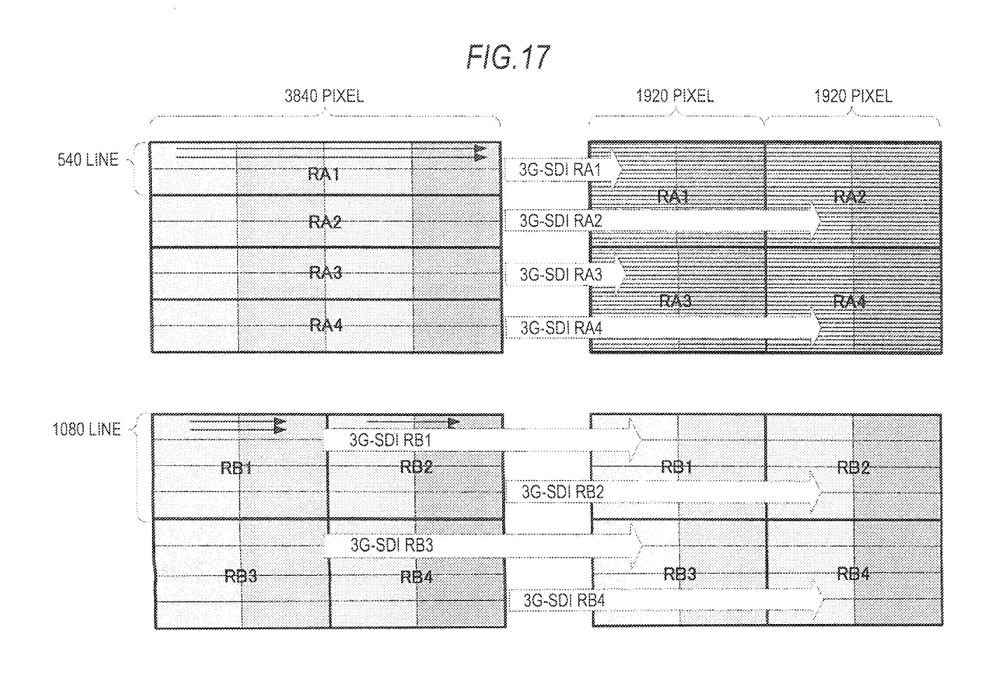

The substrates PA and PB divide and output an image corresponding to 3840 pixels by 1080 lines to two right and left screens with 1920 pixels by 1080 lines by using a splitter function. FIG. 17 shows diagrams illustrating an output order and a display image of the image data. The upper diagram in FIG. 17 indicates a case in which the splitter function is not used. The lower diagram in FIG. 17 indicates a case in which the splitter function is used. When the splitter function is not used, image data corresponding to 3840 pixels is supplied as image data corresponding to one line to one display panel of the display device. However, the resolution of the display panel is 1920 pixels by 1080 lines. The image data corresponding to one line output from the codec processing section 30 is considered as image data corresponding to two lines in the display panel. Accordingly, when the image data corresponding to 3840 pixels by 540 lines is read and supplied to each of the display panels, an image of the area corresponding to each of the display panel may not be displayed.

Accordingly, the codec processing section 30 reads and outputs the image data stored in the memory area set in advance for each of the divided screens in correspondence with the image display area. That is, the codec processing section 30 horizontally divides the screen into two screens using the splitter function and supplies the image data corresponding to 1920 pixels by 1080 lines appropriate for the resolution of the display panel to each of the display panels. In this case, the image data supplied to each of the display panels enables an image of the area corresponding to each of the display panel to be displayed, since the number of horizontal pixels and the number of vertical lines are the same as each other.

In FIGS. 15 and 17, the case has been described in which the image data is output using the 3G-SDI. However, when the HD-SDI method is used, the image data is output from four outputs (two Dual Link HD-SDI lines) in each of the substrates PA and PB.

Thus, the decoding process can be performed at high speed by dividing the decoding data and decoding the divided decoding data in parallel. Moreover, the decoding can easily be realized by the application without preparing a complicated queuing structure. Moreover, by using no queuing structure, a response does not deteriorate in random reproduction of the application and no cancellation mechanism is necessary. Since the complete processing can be realized for each requested unit, flexibility can be ensured as in software decoding. Therefore, it is possible to easily realize a decoding process on a plurality of video clips. Moreover, since it is not necessary to provide a plurality of buffers for queuing, the configuration can be simplified and thus the buffer can easily be managed.

Even when the desired number of output terminals may not be provided in the substrate having the codec processing section 30 due to the restriction on the size of the substrate, a plurality of substrates having the codec processing section 30 can be used so that the respective substrates decode the divided screens, respectively. That is, the image data of the associated display areas can be output from each output terminal using the desired number of output terminals provided in the plurality of substrates. Moreover, the buffer or the like may not be prepared to receive and transmit data, since it is not necessary to receive and transmit data from and to the substrates.

According to the second embodiment, as described above, the codec instruction section generates the first and second buffer lists in which the pointers indicating the position of the first buffer 22A used to store the data before the decoding process and the position of the second buffer 22B used to store the data after the decoding process are described in the transmission unit in accordance with the data transmission process. Moreover, the list information used to acquire the first and second buffer lists can be included in the decoding request issued from the codec instruction section. The codec processing section acquires the first and second buffer lists based on the list information included in the decoding request. The codec processing section transmits the data by the pipeline processing based on the acquired buffer lists. The codec processing section reads the data before the decoding process from the first buffer 22A and writes the data after the decoding process to the second buffer 22B. Therefore, it is possible to shorten the time necessary to obtain the decoding result in response to the decoding request from the decoding request. Moreover, it is possible to easily realize the decoding process without preparing a complicated queuing structure. Since a queuing structure is not used, no cancellation mechanism is necessary. Since the capacity of the main memory 22 and the memory of the codec processing section 30 can be reduced, the management of the plurality of buffer is not necessary. The decoding process is easily realized by a plurality of tracks.

The codec processing section 30 divides the encoded data read from the first buffer 22A for each of the divided screens by the pipeline processing, distributes the divided encoded data to the plurality of codec processors, and performs the decoding process. Therefore, since the time necessary for the decoding process is shortened, for example, the decoding result can be obtained in real time. Moreover, for example, since the transmission unit of the second buffer list is the unit of the data amount suitable for the transmission of the image data for each of the divided screens, it is possible to efficiently transmit the data by the pipeline processing.

Since the data are transmitted between the codec memory 34 and the codec processors 35-1 and 35-2 by the pipeline processing and the decoding process and the like are performed in sequence, it is possible to shorten the time necessary to obtain the decoding result image data after reading the decoding data.

The codec processing section 30 stores the image data obtained through the decoding process in the corresponding area of the memory area set in advance for each of the divided screens, and reads and outputs the stored image data in correspondence with the image display area. Therefore, even in the configuration in which one screen is configured by the plurality of display devices, an image can correctly be displayed.

The specific embodiments of the present disclosure have hitherto been described in detail. However, it should be apparent to those skilled in the art that the embodiments of the present disclosure may be modified and substituted within the scope of the gist of the present disclosure. That is, the embodiments of the present disclosure should not be construed as limiting as the embodiments have been described an examples of the present disclosure. The appended claims have to be taken into consideration to determine the gist of the present disclosure.

In the information processing apparatus and the information processing method according to the embodiments of the present disclosure, the buffer list is generated in which the pointer indicating the position of the buffer used to store at least one of the data before the codec processing and the data after the codec processing is described in the transmission unit in accordance with the data transmission process from the codec processing section. The list information used to acquire the buffer list is included in the codec request, and thus the codec request is issued to the codec processing section. The codec processing section performing the codec processing using the plurality of codec processors acquires the buffer list based on the list information included in the codec request and transmits the data by the pipeline processing based on the buffer list. The codec processing section reads the data before the codec processing from the buffer or writes the data after the codec processing to the buffer. Thus, since at least one of the data before the codec processing and the data after the codec processing is transmitted at high speed, it is possible to shorten the time necessary to obtain the codec result in response to the codec request from the issue of the codec request with the simple configuration. Accordingly, the information processing apparatus and the information processing method are suitable for, for example, an electronic apparatus recording or reproducing image data and an editing apparatus editing image data.

The present disclosure contains subject matter related to that disclosed in Japanese Priority Patent Application JP 2010-145439 filed in the Japan Patent Office on Jun. 25, 2010, the entire contents of which is hereby incorporated by reference.

What is claimed is:

1. An information processing apparatus comprising:
a codec processing section performing codec processing using a plurality of codec processors; and
a codec instruction section generating a buffer list in which a pointer indicating a position of a buffer used to store at least one of data before the codec processing and data of ter the codec processing is described in a transmission unit in accordance with a data transmission process from the codec processing section, allows list information used to acquire the buffer list to be included in a codec request, and issues the codec request to the codec processing section,
wherein the codec processing section acquires the buffer list based on the list information included in the codec request, transmits the data based on the buffer list by pipeline processing, and reads the data before the codec processing from the buffer or writes the data after the codec processing to the buffer.

2. The information processing apparatus according to claim 1, wherein the codec instruction section generates a scatter gather list of the buffer and generates the buffer list by re-listing the scatter gather list in the transmission unit.

3. The information processing apparatus according to claim 2, wherein the codec processing section performs the codec processing by distributing the data before the codec processing read from the buffer, to the plurality of codec processors.

4. The information processing apparatus according to claim 3, wherein the codec instruction section issues an encoding request as the codec request and sets, as the transmission unit, a unit of a data amount suitable for the distributing of the data and the encoding process of the codec processing section in the data transmission process of image data to be encoded.

5. The information processing apparatus according to claim 4,
wherein the codec instruction section allows screen division information to be included in the encoding request and issues the encoding request to the codec processing section, and
when the codec instruction section issues the encoding request, the codec processing section performs the encoding process by distributing the image data read from the buffer to the plurality of codec processors for each of divided screens based on the screen division information.

6. The information processing apparatus according to claim 5,
wherein the codec processing section includes a codec memory used to store encoded data obtained through the encoding process, and
the codec processing section sets, in the codec memory, an area used to store the encoded data for each of the divided screens and sets the area so as to have a size of the maximum code generation amount.

7. The information processing apparatus according to claim 3, wherein the codec instruction section issues an encoding request as the codec request and determines the transmission unit so that a data amount of invalid data added to the encoded data, which is obtained through the encoding process by the codec processing section, to allow the encoded data to have a data amount of the transmission unit is reduced to improve transmission efficiency in the data transmission process of the encoded data.

8. The information processing apparatus according to claim 3,
wherein the codec instruction section issues an decoding request as the codec request, and
when the codec instruction section issues the decoding request, the codec processing section performs a decoding process by dividing encoded data read from the buffer by the pipeline processing for each of divided screens and distributing the divided encoded data to the plurality of codec processors, respectively.

9. The information processing apparatus according to claim 8, wherein in transmission of image data obtained through the decoding process, the codec instruction section sets, as the transmission unit, a unit of a data amount suitable for the transmission of the image data for each of the divided screens.

10. The information processing apparatus according to claim 8, wherein the codec processing section stores image data obtained through the decoding process in a corresponding area of a memory area set in advance for each of the divided screens, and reads and outputs the stored image data in correspondence with an image display area.

11. The information processing apparatus according to claim 3, wherein the codec processing section performs the codec processing by supplying the data before the codec processing read from the buffer to the codec processors by the pipeline processing.

12. An information processing method comprising:
generating a buffer list in which a pointer indicating a position of a buffer used to store at least one of data before codec processing and data after the codec processing is described in a transmission unit in accordance with a data transmission process from a codec processing section performing the codec processing using a plurality of codec processors, allowing list information used to acquire the buffer list to be included in a codec request, and issuing the codec request to the codec processing section by a codec instruction section; and
acquiring the buffer list based on the list information included in the codec request, transmitting the data based on the buffer list by pipeline processing, and reading the data before the codec processing from the buffer or writing the data after the codec processing to the buffer by the codec processing section.
